(19) United States
(12) Patent Application Publication
(10) Pub. No.: US 2026/0164148 A1
(43) Pub. Date: Jun. 11, 2026

(54) PHOTOELECTRIC CONVERSION DEVICE AND PHOTODETECTION SYSTEM

(71) Applicant: CANON KABUSHIKI KAISHA, Tokyo (JP)

(72) Inventor: DAIKI SHIRAHIGE, Kanagawa (JP)

(21) Appl. No.: 19/408,210

(22) Filed: Dec. 3, 2025

(30) Foreign Application Priority Data
Dec. 5, 2024 (JP) 2024-211994

(51) Int. Cl. H04N 25/773; G06T 7/55; H04N 25/79

(52) U.S. Cl. CPC H04N 25/773; G06T 7/55; H04N 25/79; G06T 2207/10028; G06T 2207/30261

(57) ABSTRACT

A photoelectric conversion device includes a first semiconductor layer provided with an avalanche photodiode, a second semiconductor layer arranged so as to overlap the first semiconductor layer in a plan view, a first insulating portion and a second insulating portion provided so as to penetrate the second semiconductor layer, a first through-electrode penetrating the first insulating portion and electrically connected to a first electrode of the avalanche photodiode, and a second through-electrode penetrating the second insulating portion and electrically connected to a second electrode of the avalanche photodiode. The first insulating portion and the second insulating portion are provided apart from each other in the second semiconductor layer in the plan view.

### BACKGROUND

### Field of the Technology

The present disclosure relates to a photoelectric conversion device and a photodetection system.

### Description of the Related Art

International publication No. WO2022/091607 discusses a stacked-type image sensor constituted by stacking a plurality of structures each including a semiconductor layer. In international publication No. WO2022/091607, a through-electrode provided so as to penetrate the semiconductor layer is discussed as one of the structures electrically connecting the plurality of structures.

However, in international publication No. WO2022/091607, no particular considerations are given to the arrangement of the through-electrodes penetrating the semiconductor layer, and there is a possibility that the arrangement and layout of elements and circuits arranged in the semiconductor layer through which the through-electrodes penetrate are limited.

### SUMMARY

The present disclosure is directed to a technique for increasing an arrangement area of an element or a circuit arranged in a semiconductor layer and improving the degree of freedom of a layout in a photoelectric conversion device having a through-electrode penetrating the semiconductor layer.

An aspect of the present disclosure provides a photoelectric conversion device that includes a first semiconductor layer provided with an avalanche photodiode; a second semiconductor layer overlapping the first semiconductor layer, in a plan view; a first insulating portion and a second insulating portion each configured to penetrate the second semiconductor layer; a first through-electrode penetrating the first insulating portion and electrically connected to a first electrode of the avalanche photodiode; and a second through-electrode penetrating the second insulating portion and electrically connected to a second electrode of the avalanche photodiode, with the first insulating portion and the second insulating portion being provided apart from each other in the second semiconductor layer, in the plan view.

Features of the present disclosure will become apparent from the following description of embodiments with reference to the attached drawings. The following description of embodiments is described by way of example.

### BRIEF DESCRIPTION OF THE DRAWINGS

FIG. 1 is a block diagram illustrating a configuration example of a photoelectric conversion device according to a first embodiment.

FIG. 2 is a block diagram illustrating another configuration example of the photoelectric conversion device according to the first embodiment.

FIG. 3 is a block diagram illustrating a configuration example of a pixel of the photoelectric conversion device according to the first embodiment.

FIG. 4A, FIG. 4B, and FIG. 4C are diagrams illustrating a basic operation of the photoelectric conversion unit in the photoelectric conversion device according to the first embodiment.

FIG. 5 is a perspective view illustrating a configuration example of the photoelectric conversion device according to the first embodiment.

FIG. 6A and FIG. 6B are plan views of the pixels in the photoelectric conversion device according to the first embodiment.

FIG. 7 is a cross-sectional view of the pixels in the photoelectric conversion device according to the first embodiment.

FIG. 8A and FIG. 8B are plan views illustrating arrangement examples of quenching elements and waveform shaping circuits in the photoelectric conversion device according to the first embodiment.

FIG. 9A and FIG. 9B are plan views of pixels in a photoelectric conversion device according to a second embodiment.

FIG. 10 is a cross-sectional view of the pixels in the photoelectric conversion device according to the second embodiment.

FIG. 11A and FIG. 11B are plan views of pixels in a photoelectric conversion device according to a third embodiment.

FIG. 12 is a cross-sectional view of the pixels in the photoelectric conversion device according to the third embodiment.

FIG. 13A and FIG. 13B are plan views of pixels in a photoelectric conversion device according to a fourth embodiment.

FIG. 14 is a cross-sectional view of the pixels in the photoelectric conversion device according to the fourth embodiment.

FIG. 15A and FIG. 15B are plan views of pixels in a photoelectric conversion device according to a fifth embodiment.

FIG. 16 is a cross-sectional view of the pixels in the photoelectric conversion device according to the fifth embodiment.

FIG. 17A and FIG. 17B are plan views of pixels in a photoelectric conversion device according to a sixth embodiment.

FIG. 18 is a cross-sectional view of the pixels in the photoelectric conversion device according to the sixth embodiment.

FIG. 19A and FIG. 19B are plan views of a pixel in a photoelectric conversion device according to a seventh embodiment.

FIG. 20 is a cross-sectional view of the pixel in the photoelectric conversion device according to the seventh embodiment.

FIG. 21A, FIG. 21B, and FIG. 21C are plan views of a pixel in a photoelectric conversion device according to an eighth embodiment.

FIG. 22 is a cross-sectional view of the pixel in the photoelectric conversion device according to the eighth embodiment.

FIG. 23A, FIG. 23B, and FIG. 23C are plan views of a pixel in a photoelectric conversion device according to a ninth embodiment.

FIG. 24 is a cross-sectional view of the pixel in the photoelectric conversion device according to the ninth embodiment.

FIG. 25A, FIG. 25B, and FIG. 25C are plan views of a pixel in a photoelectric conversion device according to a tenth embodiment.

FIG. 26 is a cross-sectional view of the pixel in the photoelectric conversion device according to the tenth embodiment.

FIG. 27 is a cross-sectional view of a pixel in a photoelectric conversion device according to an eleventh embodiment.

FIG. 28 is a cross-sectional view of a pixel in a photoelectric conversion device according to a twelfth embodiment.

FIG. 29 is a plan view of the pixel in the photoelectric conversion device according to the twelfth embodiment.

FIG. 30 is a block diagram illustrating a schematic configuration of a photodetection system according to a thirteenth embodiment.

FIG. 31 is a block diagram illustrating a schematic configuration of a range image sensor according to a fourteenth embodiment.

FIG. 32 is a schematic diagram illustrating a configuration example of an endoscopic surgical system according to a fifteenth embodiment.

FIG. 33A, FIG. 33B, and FIG. 33C are schematic diagrams illustrating a configuration example of a movable object according to a sixteenth embodiment.

FIG. 34 is a block diagram illustrating a schematic configuration of a photodetection system according to the sixteenth embodiment.

FIG. 35 is a flowchart illustrating the operation of the photodetection system according to the sixteenth embodiment.

FIG. 36A and FIG. 36B are schematic diagrams illustrating a schematic configuration of a photodetection system according to a seventeenth embodiment.

### DESCRIPTION OF THE EMBODIMENTS

Hereinafter, embodiments of the present disclosure will be described in detail with reference to the accompanying drawings. Note that the following embodiments do not limit the technology according to the claims. Although multiple features are described in the embodiments, not all of these multiple features are essential to the present disclosure, and multiple features may be arbitrarily combined. In the following description, a term indicating a specific direction or position (for example, “up”, “down”, “right”, “left” and other terms including those terms) is used as necessary. The use of these terms is to facilitate understanding of the embodiments with reference to the drawings, and the technical scope of the present disclosure is not limited by the meanings of these terms. In addition, sizes and positional relationships of members illustrated in the drawings may be exaggerated for clarity of description.

In each of the embodiments described below, a photoelectric conversion device for imaging purposes will be mainly described as an example of a semiconductor device. However, the embodiments are not limited to photoelectric conversion devices for imaging purposes and may be applied to other semiconductor devices. For example, other examples of the photoelectric conversion device include a ranging device (a device for distance measurement and the like using a focus detection or a time of flight (TOF)), and a photometric device (a device for measuring the amount of incident light).

### First Embodiment

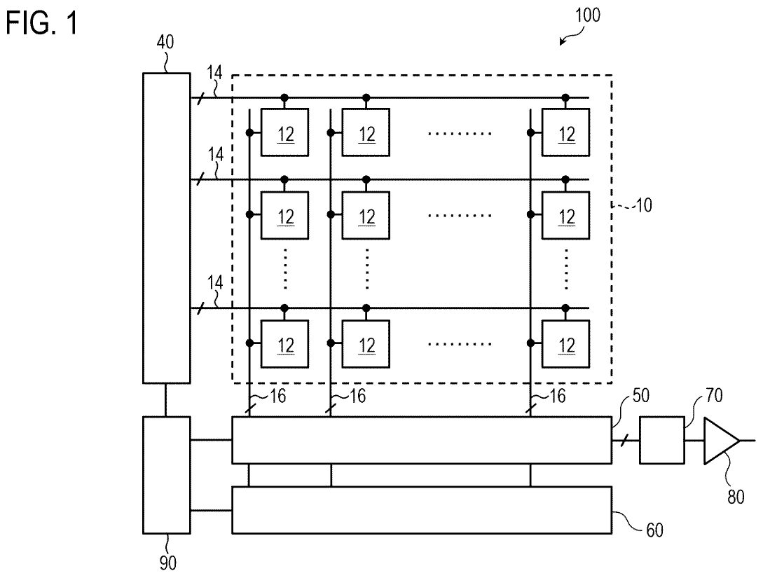

A schematic configuration of a photoelectric conversion device according to a first embodiment will be described with reference to FIG. 1. FIG. 1 is a block diagram illustrating a schematic configuration of a photoelectric conversion device according to the present embodiment.

As illustrated in FIG. 1, the photoelectric conversion device 100 according to the present embodiment includes a pixel region 10, a vertical scanning circuit unit 40, a readout circuit unit 50, a horizontal scanning circuit unit 60, a digital front end (DFE) 70, a transmitter circuit unit (TX) 80, and a control pulse generation unit 90.

The pixel region 10 is provided with a plurality of pixels 12 arranged in an array so as to form a plurality of rows and a plurality of columns. As described later, each of the plurality of pixels 12 may include a photoelectric conversion unit including a photoelectric conversion element and a signal processing unit that processes a signal output from the photoelectric conversion unit. The number of pixels 12 constituting the pixel region 10 is not particularly limited. For example, like a general digital camera, the pixel region 10 may be constituted by a plurality of pixels 12 arranged in an array of several thousand rows×several thousand columns. Alternatively, the pixel region 10 may include a plurality of pixels 12 arranged in one row or one column. Alternatively, one pixel 12 may constitute the pixel region 10.

In each row of the pixel array of the pixel region 10, a control line 14 is arranged so as to extend in a first direction (lateral direction in FIG. 1). Each of the control lines 14 is connected to the pixels 12 arranged in the first direction in the corresponding row, respectively, and forms a signal line common to these pixels 12. The first direction in which the control lines 14 extend may be referred to as a row direction or a horizontal direction. Each of the control lines 14 may include a plurality of signal lines for supplying a plurality of types of control signals to the pixels 12.

Further, in each column of the pixel array of the pixel region 10, an output line 16 is arranged so as to extend in a second direction (vertical direction in FIG. 1) intersecting the first direction. Each of the output lines 16 is connected to the pixels 12 arranged in the second direction in the corresponding column, respectively, and forms a signal line common to these pixels 12. The second direction in which the output lines 16 extend may be referred to as a column direction or a vertical direction. Each of the output lines 16 may include a plurality of signal lines. For example, each of the output lines 16 may include a plurality of signal lines for transferring a digital signal of a plurality of bits output from the pixel 12 on a bit-by-bit basis.

The control line 14 of each row is connected to the vertical scanning circuit unit 40. The vertical scanning circuit unit 40 is a control circuit having a function of generating a control signal for driving the pixels 12 in response to a control signal output from the control pulse generation unit 90 and supplying the generated control signal to the pixels 12 via the control line 14. A logic circuit such as a shift register or an address decoder may be used as the vertical scanning circuit unit 40. The vertical scanning circuit unit 40 sequentially scans the pixels 12 in the pixel region 10 row by row to output the pixel signals of the pixels 12 to the readout circuit unit 50 via the output lines 16.

The output line 16 of each column is connected to the readout circuit unit 50. The readout circuit unit 50 includes a plurality of holding units provided corresponding to each column of the pixel array of the pixel region 10 and has a function of holding the pixel signals of the pixels 12 of the respective columns output from the pixel region 10 in units of rows via the output lines 16 in the holding units of the corresponding columns.

The horizontal scanning circuit unit 60 is a control circuit having a function of generating a control signal for reading out a pixel signal from the holding unit of each column of the readout circuit unit 50 in response to a control signal output from the control pulse generation unit 90 and supplies the generated control signal to the readout circuit unit 50. A logic circuit such as a shift register or an address decoder may be used as the horizontal scanning circuit unit 60. The horizontal scanning circuit unit 60 sequentially scans the holding units of the respective columns of the readout circuit unit 50 to sequentially output the pixel signals held in the holding units to the DFE 70.

The DFE 70 is a signal processing circuit unit that performs predetermined digital signal processing on the pixel signal output from the readout circuit unit 50. The DFE 70 sequentially outputs the pixel signals subjected to the digital signal processing to the TX 80.

The TX 80 is a circuit unit for outputting the pixel signal output from the readout circuit unit 50 to the outside of the photoelectric conversion device 100 and includes an external interface circuit. The external interface circuit included in the TX 80 is not particularly limited. As the external interface circuit, for example, a SERializer/DESerializer (SerDes) transmission circuit may be applied. Examples of the SerDes transmission circuit include a low voltage differential signaling (LVDS) circuit and a scalable low voltage signaling (SLVS) circuit.

The control pulse generation unit 90 is a control circuit for generating control signals for controlling the operations and timings of the vertical scanning circuit unit 40, the readout circuit unit 50, and the horizontal scanning circuit unit 60, and supplying the generated control signals to each functional block. At least a part of the control signals for controlling the operations and timings of the vertical scanning circuit unit 40, the readout circuit unit 50, and the horizontal scanning circuit unit 60 may be supplied from the outside of the photoelectric conversion device 100.

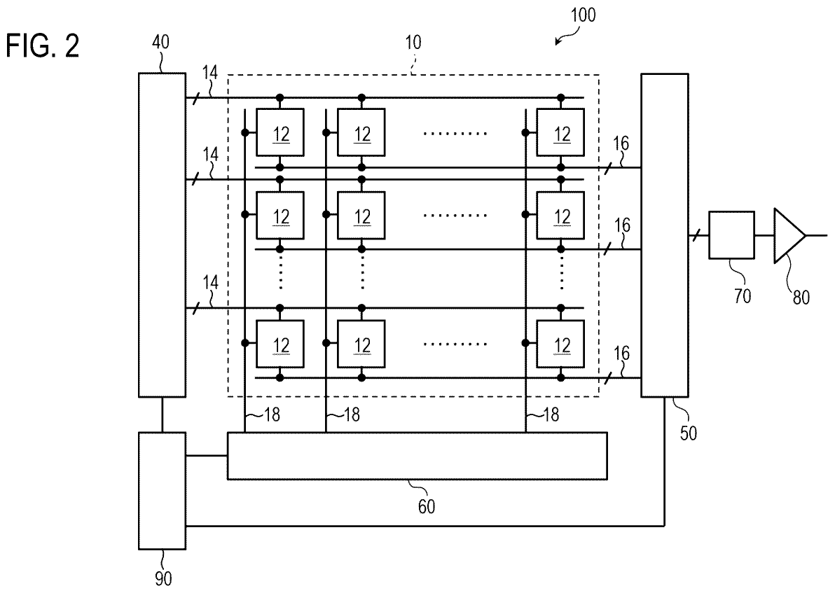

The connection mode of each functional block of the photoelectric conversion device 100 is not limited to the configuration example of FIG. 1 and may be configured as illustrated in, e.g., FIG. 2.

In the configuration example of FIG. 2, the output line 16 extending in the first direction is arranged in each row of the pixel array of the pixel region 10. Each of the output lines 16 is connected to the pixels 12 arranged in the first direction in the corresponding row, respectively, and forms a signal line common to these pixels 12. A control line 18 extending in the second direction is arranged in each column of the pixel array of the pixel region 10. Each of the control lines 18 is connected to the pixels 12 arranged in the second direction in the corresponding column, respectively, and forms a signal line common to these pixels 12.

The control line 18 of each column is connected to the horizontal scanning circuit unit 60. The horizontal scanning circuit unit 60 generates a control signal for reading out the pixel signal from the pixel 12 in response to a control signal output from the control pulse generation unit 90 and supplies the generated control signal to the pixel 12 via the control line 18. Specifically, the horizontal scanning circuit unit 60 sequentially scans the plurality of pixels 12 in the pixel region 10 in units of columns to output pixel signals of the pixels 12 in the respective rows belonging to the selected column to the output lines 16.

The output line 16 of each row is connected to the readout circuit unit 50. The readout circuit unit 50 includes a plurality of holding units provided corresponding to the respective rows of the pixel array of the pixel region 10 and has a function of holding the pixel signals of the pixels 12 of the respective rows output from the pixel region 10 in units of columns via the output lines 16 in the holding units of the corresponding rows.

The readout circuit unit 50 sequentially outputs the pixel signals held in the holding units of the respective rows to the DFE 70 in response to a control signal output from the control pulse generation unit 90.

Other configurations in the configuration example of FIG. 2 may be the same as those in the configuration example of FIG. 1.

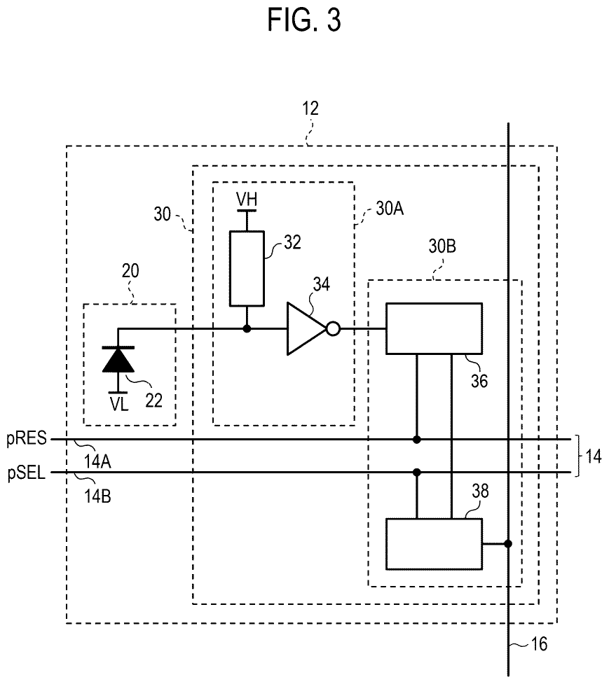

FIG. 3 is a block diagram illustrating a configuration example of the pixel 12. As illustrated in FIG. 3, each pixel 12 includes a photoelectric conversion unit 20 and a signal processing unit 30. The photoelectric conversion unit 20 includes a photoelectric conversion element 22 and outputs a signal according to incident light. The signal processing unit 30 is a signal processing circuit that processes the signal output from the photoelectric conversion unit 20. The signal processing unit 30 may include, for example, a functional block 30A including a quenching element 32 and a waveform shaping circuit 34, and a functional block 30B including a selection circuit 38 and a processing circuit 36. In the case of the pixel configuration illustrated in FIG. 3, the control line 14 of each row may include a signal line 14A to which the control signal pRES is supplied from the vertical scanning circuit unit 40 and a signal line 14B to which the control signal pSEL is supplied from the vertical scanning circuit unit 40.

The photoelectric conversion element 22 may be an avalanche photodiode (APD). An anode of the APD constituting the photoelectric conversion element 22 is connected to a node to which a voltage VL is supplied. A cathode of the APD constituting the photoelectric conversion element 22 is connected to one terminal of the quenching element 32. A connection node between the photoelectric conversion element 22 and the quenching element 32 is an output node of the photoelectric conversion unit 20. The other terminal of the quenching element 32 is connected to a node to which a voltage VH higher than the voltage VL is supplied. The voltage VL and the voltage VH are set so that a reverse bias voltage sufficient for the APD to perform the avalanche multiplication operation is applied. In one example, a negative high voltage is applied as the voltage VL, and a positive voltage comparable to the power supply voltage is applied as the voltage VH. For example, the voltage VL is-30 V, and the voltage VH is 1 V.

The photoelectric conversion element 22 may be configured by an APD as described above. When a reverse bias voltage sufficient to perform the avalanche multiplication operation is supplied to the APD, carriers generated by light incident on the APD cause avalanche multiplication, and an avalanche current is generated. The operation modes in a state where the reverse bias voltage is supplied to the APD include a Geiger mode and a linear mode. The Geiger mode is an operation mode in which a voltage applied between the anode and the cathode is set to a reverse bias voltage larger than a breakdown voltage of the APD. The linear mode is an operation mode in which a voltage applied between the anode and the cathode is set to a reverse bias voltage close to or lower than the breakdown voltage of the APD. An APD that operates in Geiger mode is referred to as a single-photon avalanche diode (SPAD). The APD constituting the photoelectric conversion element 22 may be operated in the linear mode or in the Geiger mode, but the SPAD having a larger potential difference than the APD in the linear mode and having a remarkable improvement effect of the signal-to-noise ratio is more preferable.

Although the anode of the APD is set to a fixed potential and a signal is extracted from the cathode side in the circuit configuration of FIG. 3, the cathode of the APD may be set to a fixed potential and a signal may be extracted from the anode side. In the former case, the signal charge is an electron. In the latter case, the signal charge is a hole. Further, in the present embodiment, a case where one node of the APD is set to a fixed potential will be described, but the potentials of both nodes may vary. In the following description, a configuration in which electrons are used as the signal charge will be described. When holes are used as the signal charge, the conductivity type of the semiconductor region constituting each part of the photoelectric conversion element 22 is opposite to the conductivity type of the configuration described below.

The quenching element 32 has a function of converting a change in the avalanche current generated in the photoelectric conversion element 22 into a voltage signal. In addition, the quenching element 32 functions as a load circuit (quenching circuit) at the time of signal multiplication by avalanche multiplication and has a function of suppressing avalanche multiplication by reducing a voltage applied to the photoelectric conversion element 22. The operation in which the quenching element 32 suppresses avalanche multiplication is called a quenching operation. The quenching element 32 has a function of returning the voltage supplied to the photoelectric conversion element 22 to the voltage VH by flowing a current corresponding to the voltage drop due to the quenching operation. The operation of returning the voltage supplied from the quenching element 32 to the photoelectric conversion element 22 to the voltage VH is called a recharge operation. The quenching element 32 may be configured by a resistor, a MOS transistor, or the like.

The waveform shaping circuit 34 includes an input node to which the output signal of the photoelectric conversion unit 20 is supplied and an output node. The waveform shaping circuit 34 has a function of converting an analog signal supplied from the photoelectric conversion unit 20 into a pulse signal. The waveform shaping circuit 34 may be configured by a logic circuit including a NOT circuit (inverter circuit), a NOR circuit, a NAND circuit, and the like. The output node of the waveform shaping circuit 34 is connected to the processing circuit 36.

The processing circuit 36 has an input node to which the output signal of the waveform shaping circuit 34 is supplied, an input node connected to the control line 14, and an output node. The processing circuit 36 has a function of performing predetermined signal processing on the output signal of the waveform shaping circuit 34 and holding the processed signal or the processing result. Although not particularly limited, the processing circuit 36 may be, for example, a counter circuit. In this case, the processing circuit 36 counts pulses superimposed on the signal output from the waveform shaping circuit 34 and holds a count value which is a count result. The signal supplied from the vertical scanning circuit unit 40 to the processing circuit 36 via the control line 14 may include an enable signal for controlling a pulse counting period (exposure period), a reset signal for resetting a count value held by the processing circuit 36, and the like. FIG. 3 illustrates, as an example, a reset signal (control signal pRES) supplied via the signal line 14A. The output node of the processing circuit 36 is connected to the selection circuit 38.

The selection circuit 38 has a function of switching an electrical connection state (connection or non-connection) between the processing circuit 36 and the output line 16. The selection circuit 38 switches the connection state between the processing circuit 36 and the output line 16 according to a selection signal supplied from the vertical scanning circuit unit 40 via the control line 14 (or a selection signal supplied from the horizontal scanning circuit unit 60 via the control line 18 in the configuration example of FIG. 2). FIG. 3 illustrates, as an example, a selection signal (control signal pSEL) supplied via the signal line 14B. The processing circuit 36 may include buffer circuit for outputting signals.

The pixel 12 is typically a unit structure that outputs a pixel signal for forming an image. However, in the case of aiming at distance measurement using a TOF method, the pixel 12 does not necessarily need to be a unit structure that outputs a pixel signal for forming an image. That is, the pixel 12 may be a unit structure that outputs a signal for measuring the time at which light arrives and the amount of light.

One signal processing unit 30 is not necessarily provided for each pixel 12, and one signal processing unit 30 may be provided for a plurality of pixels 12. In this case, the signal processing of the plurality of pixels 12 may be sequentially performed using one signal processing unit 30.

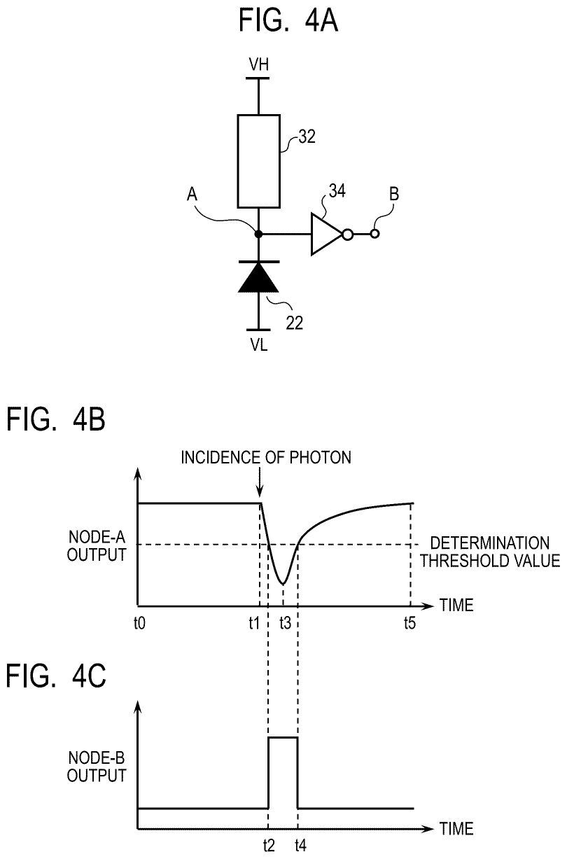

Next, a basic operation of the photoelectric conversion unit 20 in the photoelectric conversion device according to the present embodiment will be described with reference to FIG. 4A to FIG. 4C. FIG. 4A to FIG. 4C are diagrams illustrating the basic operation of the photoelectric conversion element 22, the quenching element 32, and the waveform shaping circuit 34 in the photoelectric conversion device according to the present embodiment. FIG. 4A is a circuit diagram of the photoelectric conversion element 22, the quenching element 32, and the waveform shaping circuit 34. FIG. 4B illustrates the waveform of the signal at the input node (node-A) of the waveform shaping circuit 34. FIG. 4C illustrates the waveform of the signal at the output node (node-B) of the waveform shaping circuit 34. Here, in order to simplify the description, it is assumed that the waveform shaping circuit 34 is configured by an inverter circuit.

At time t0, a reverse bias voltage having a potential difference corresponding to (VH-VL) is applied to the photoelectric conversion element 22. Although a reverse bias voltage sufficient to cause avalanche multiplication is applied between the anode and the cathode of the APD constituting the photoelectric conversion element 22, carriers serving as seeds of avalanche multiplication do not exist in a state where photons are not incident on the photoelectric conversion element 22. Therefore, avalanche multiplication does not occur in the photoelectric conversion element 22, and no current flows through the photoelectric conversion element 22.

At the subsequent time t1, it is assumed that a photon is incident on the photoelectric conversion element 22. When a photon enters the photoelectric conversion element 22, an electron-hole pair is generated by photoelectric conversion, avalanche multiplication occurs using these carriers as seeds, and an avalanche multiplication current flows through the photoelectric conversion element 22. When the avalanche multiplication current flows through the quenching element 32, a voltage drop occurs due to the quenching element 32, and the voltage of the node-A starts to drop. When the voltage drop amount of the node-A becomes large and the avalanche multiplication is stopped at time t3, the voltage level of the node-A no longer drops.

When the avalanche multiplication in the photoelectric conversion element 22 is stopped, a current that compensates for the voltage drop flows from the node to which the voltage VH is supplied to the node-A through the quenching element 32, and the voltage of the node-A gradually increases. Thereafter, at time t5, the node-A is settled to the original voltage level.

The waveform shaping circuit 34 binarizes the signal input from the node-A according to a predetermined determination threshold value and outputs the signal from the node-B. Specifically, the waveform shaping circuit 34 outputs a low-level signal from the node-B when the voltage level of the node-A exceeds the determination threshold value, and outputs a high-level signal from the node-B when the voltage level of the node-A is equal to or less than the determination threshold value. For example, as illustrated in FIG. 4B, it is assumed that the voltage of the node-A is equal to or lower than the determination threshold value in the period from the time t2 to the time t4. In this case, as illustrated in FIG. 4C, the signal level at the node-B becomes low-level in the period from the time t0 to the time t2 and the period from the time t4 to the time t5 and becomes high-level in the period from the time t2 to the time t4.

Thus, the analog signal input from the node-A is waveform-shaped into a digital signal by the waveform shaping circuit 34. A pulse signal output from the waveform shaping circuit 34 in response to incidence of a photon on the photoelectric conversion element 22 is a photon detection pulse signal.

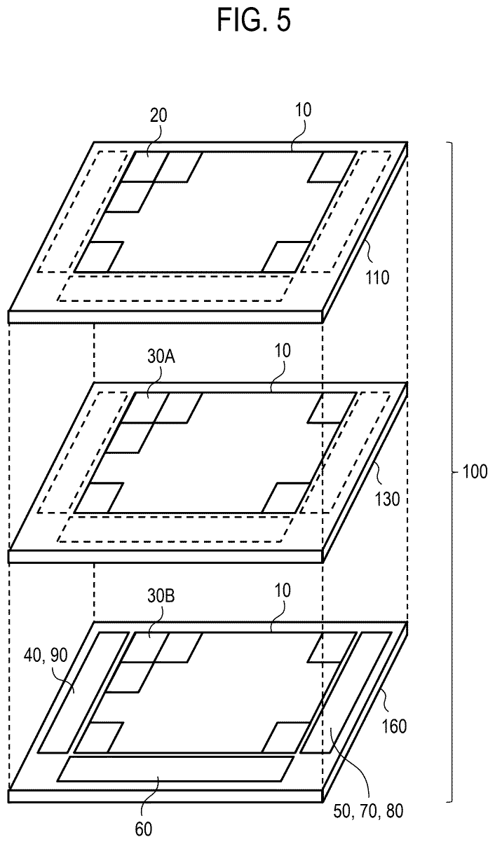

The photoelectric conversion device 100 according to the present embodiment may be configured as a stacked-type photoelectric conversion device in which a plurality of substrates is stacked. For example, as illustrated in FIG. 5, the photoelectric conversion device 100 may be configured by stacking three substrates of the sensor substrate 110, the circuit substrate 130, and the circuit substrate 160 and electrically connecting the substrates to each other.

In the case of the configuration example of FIG. 5, at least the photoelectric conversion unit 20 among the constituent elements of the pixel 12 may be arranged on the sensor substrate 110. A functional block 30A of the signal processing unit 30 among the constituent elements of the pixels 12 may be arranged on the circuit substrate 130. A functional block 30B of the signal processing unit 30 among the constituent elements of the pixels 12 may be arranged on the circuit substrate 160. By arranging the functional block 30A including the high-voltage element and the functional block 30B including the logic circuit on different substrates, the functional blocks may be manufactured separately by using appropriate manufacturing processes, and as a result, the performance of the photoelectric conversion device may be improved.

Each of the sensor substrate 110, the circuit substrate 130, and the circuit substrate 160 may be provided with the pixel region 10 so as to overlap each other in a plan view. The photoelectric conversion unit 20, the functional block 30A, and the functional block 30B of each of the plurality of pixels 12 configuring the pixel region 10 may be provided on the sensor substrate 110, the circuit substrate 130, and the circuit substrate 160, respectively, so as to overlap each other in a plan view. Herein, the plan view refers to a view from a direction perpendicular to the light incident surface of the sensor substrate 110. When the light incident surface of the semiconductor layer is a rough surface as viewed microscopically, a plan view is defined with reference to the light incident surface of the semiconductor layer as viewed macroscopically. The photoelectric conversion unit 20 and the functional block 30A, and the functional block 30A and the functional block 30B may be electrically connected to each other via interconnections provided for each pixel 12.

The circuit substrates 130 and 160 may further include the vertical scanning circuit unit 40, the readout circuit unit 50, the horizontal scanning circuit unit 60, the DFE 70, the TX 80, and the control pulse generation unit 90. The vertical scanning circuit unit 40, the readout circuit unit 50, the horizontal scanning circuit unit 60, the DFE 70, the TX 80, and the control pulse generation unit 90 may be arranged around the pixel region 10 on the circuit substrates 130 and 160. Each of the vertical scanning circuit unit 40, the readout circuit unit 50, the horizontal scanning circuit unit 60, the DFE 70, the TX80, and the control pulse generation unit 90 may be provided on one of the circuit substrates 130 and 160 or may be provided by being divided into the circuit substrates 130 and 160.

By configuring the stacked-type photoelectric conversion device 100, it is possible to increase the degree of integration of elements and achieve higher functionality. In particular, by arranging the photoelectric conversion unit 20 and the signal processing unit 30 on different substrates, the photoelectric conversion elements 22 may be arranged at high density without sacrificing the light receiving area of the photoelectric conversion elements 22, and the photon detection efficiency may be improved. In addition, by arranging the functional block 30A and the functional block 30B of the signal processing unit 30 on different substrates, it is possible to achieve high integration and high functionality of the processing circuit 36 constituting the functional block 30B while arranging the photoelectric conversion elements 22 at high density.

Although FIG. 5 illustrates a configuration in which three substrates of the sensor substrate 110, the circuit substrate 130, and the circuit substrate 160 are stacked, a configuration in which the circuit of the circuit substrate 130 and the circuit of the circuit substrate 160 are arranged on one substrate and two substrates are stacked may be employed. Alternatively, a structure in which four or more substrates are stacked may be employed.

In FIG. 5, a diced chip is assumed as the sensor substrate 110 and the circuit substrates 130 and 160, but the sensor substrate 110 and the circuit substrates 130 and 160 are not limited to chips. For example, each of the sensor substrate 110 and the circuit substrates 130 and 160 may be a wafer. In addition, the sensor substrate 110 and the circuit substrates 130 and 160 may be laminated in a wafer state and then diced or may be stacked and bonded after being formed into chips.

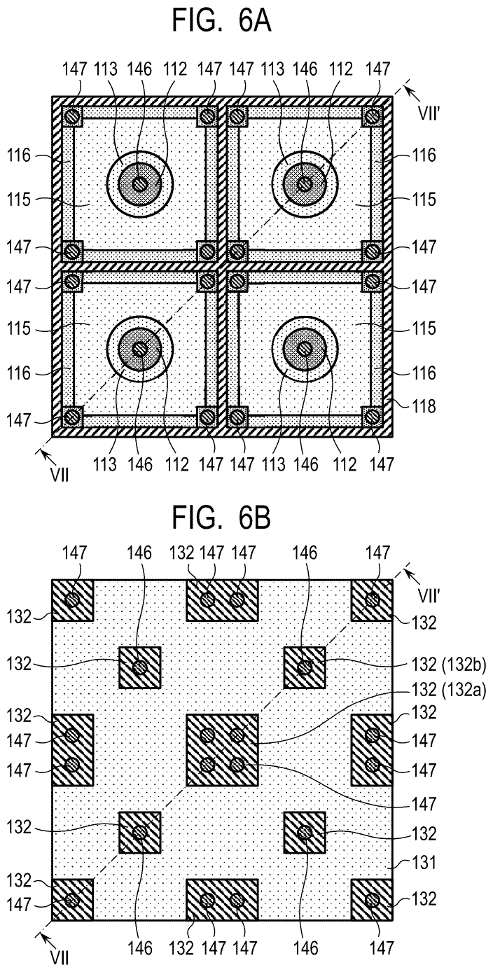

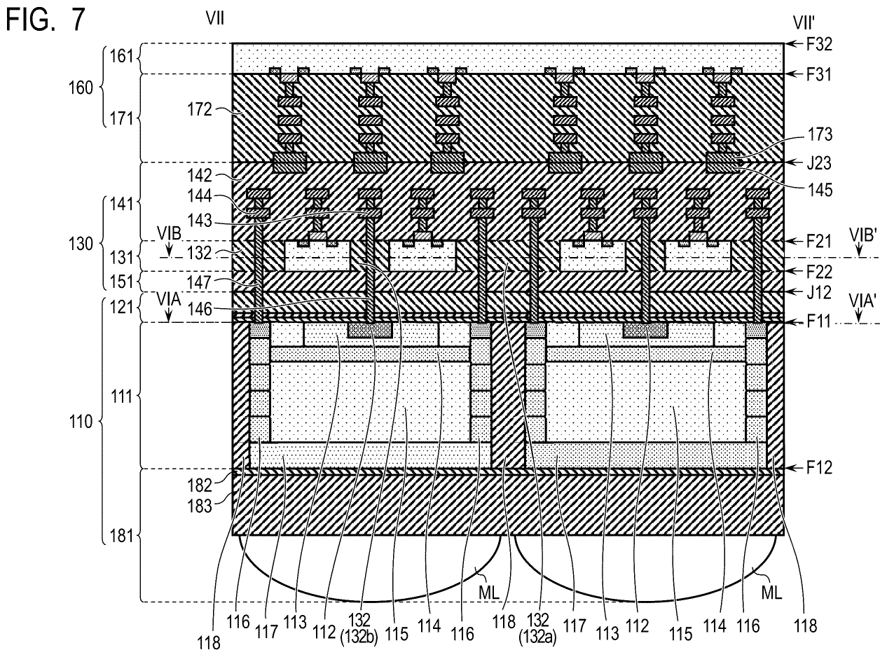

Next, a specific structure of the photoelectric conversion element 22 in the photoelectric conversion device 100 according to the present embodiment will be described with reference to FIG. 6A to FIG. 7. FIG. 6A and FIG. 6B are plan views illustrating the structure of the pixel in the photoelectric conversion device according to the present embodiment. FIG. 7 is a schematic cross-sectional view illustrating the structure of the pixel in the photoelectric conversion device according to the present embodiment.

FIG. 6A and FIG. 6B are plan views of four pixels 12 of two rows×two columns arranged adjacent to each other among the plurality of pixels 12 constituting the pixel region 10. The direction along the line VII-VII′ in FIG. 6A and FIG. 6B is the diagonal direction of the pixel 12. FIG. 7 is a cross-sectional view taken along the line VII-VII′ of FIG. 6A and FIG. 6B, taken along a plane perpendicular to the light incident plane. FIG. 6A is a plan view of a plane parallel to the light incident surface including the line VIA-VIA′ of FIG. 7 as viewed from a side opposite to the light incident surface. FIG. 6B is a plan view of a plane parallel to the light incident surface including the line VIB-VIB′ of FIG. 7 as viewed from a side opposite to the light incident surface.

FIG. 7 illustrates an example of a photoelectric conversion device configured by stacking three substrates of the sensor substrate 110, the circuit substrate 130, and the circuit substrate 160. The sensor substrate 110 includes a semiconductor layer 111 (a first semiconductor layer) having a first face F11 and a second face F12 opposite to the first face, an insulating layer 121 provided on a side of the first face F11 of the semiconductor layer 111, and an optical structure layer 181 provided on a side of the second face F12 of the semiconductor layer 111. The circuit substrate 130 includes a semiconductor layer 131 (a second semiconductor layer) having a first face F21 and a second face F22 opposite to the first face F21, an interconnection structure layer 141 provided on a side of the first face F21 of the semiconductor layer 131, and an insulating layer 151 provided on a side of the second face F22 of the semiconductor layer 131. The circuit substrate 160 includes a semiconductor layer 161 having a first face F31 and a second face F32 opposite to the first face F31, and an interconnection structure layer 171 provided on a side of the first face F31 of the semiconductor layer 161.

At least the photoelectric conversion elements 22 among the constituent elements of the plurality of pixels 12 may be provided in the semiconductor layer 111. FIG. 7 illustrates two adjacent pixels 12 among the plurality of pixels 12 constituting the pixel region 10. The photoelectric conversion element 22 is configured to supply a drive voltage from the side of the first face F11 and output a photon detection pulse signal to the side of the first face F11. The photoelectric conversion element 22 is configured to detect light incident from the second face F12 which is the back surface side of the semiconductor layer 111. That is, the photoelectric conversion device according to the present embodiment is a so-called back-illuminated photoelectric conversion device.

The structure of the photoelectric conversion element 22 is not particularly limited. Here, as an example, it is assumed that the photoelectric conversion element 22 is a charge collection type SPAD including n-type semiconductor regions 112, 113, and 115 and p-type semiconductor regions 114, 116, and 117 is provided in the semiconductor layer 111 having a low impurity concentration.

The semiconductor layer 111 is obtained by thinning a semiconductor substrate, for example, a single crystalline silicon substrate and contains an n-type impurity or a p-type impurity at a predetermined concentration. In the present embodiment, as an example, a semiconductor layer 111 obtained by thinning an n-type silicon substrate having a low impurity concentration is assumed.

The p-type semiconductor region 117 is provided on the side of the second face F12 of the semiconductor layer 111 in a cross-sectional view. Herein, the cross-sectional view refers to a view of a cross section of a semiconductor layer perpendicular to a light incident surface viewed from a normal direction. The p-type semiconductor region 117 is provided over the entire region in which the photoelectric conversion element 22 is arranged, and overlaps the n-type semiconductor regions 112 and 113 and the p-type semiconductor regions 114, 115, and 116, in the plan view. When the back-illuminated photoelectric conversion device is configured, the p-type semiconductor region 117 is preferably arranged so as to be in contact with the second face F12. With this configuration, it is possible to prevent generation of a dark current on the second face F12. The p-type semiconductor region 116 is provided at a boundary portion between the photoelectric conversion elements 22 of the adjacent pixels 12. That is, the p-type semiconductor region 116 is provided so as to surround each of the regions in which the photoelectric conversion elements 22 are arranged in the plan view. The p-type semiconductor region 116 is provided from the first face F11 of the semiconductor layer 111 to a depth at which the p-type semiconductor region 117 is arranged. A portion of the p-type semiconductor region 116 in contact with the first face F11 is a contact region having a high impurity concentration.

The n-type semiconductor regions 112, 113, and 115 and the p-type semiconductor region 114 are provided inside the region surrounded by the p-type semiconductor regions 116 and 117. The n-type semiconductor region 112 is a region constituting the cathode of the APD and is provided on the side of the first face F11 of the semiconductor layer 111 so as to be isolated from the p-type semiconductor region 116. The n-type semiconductor region 113 is provided so as to surround the n-type semiconductor region 112. The p-type semiconductor region 114 is a region constituting the anode of the APD and is provided closer to the second face F12 than the n-type semiconductor regions 112 and 113. The p-type semiconductor region 114 is in contact with the p-type semiconductor region 116 in a peripheral portion in the plan view. The n-type semiconductor region 115 is provided between the p-type semiconductor region 114 and the p-type semiconductor region 117.

A pixel isolation portion 118 may also be provided inside the p-type semiconductor region 116. The pixel isolation portion 118 has a function of preventing light from leaking into the adjacent photoelectric conversion element 22 and is preferably a wall-like body surrounding each region in which the photoelectric conversion element 22 is arranged. The pixel isolation portion 118 may be configured by, for example, burying an insulating member or a metal member in a groove formed in the semiconductor layer 111. Although the pixel isolation portion 118 is provided from the first face F11 to the second face F12 of the semiconductor layer 111 in the configuration example of FIG. 7, the pixel isolation portion 118 may not necessarily reach the second face F12 from the first face F11.

The insulating layer 121 may be formed of one insulating film or may be formed by stacking a plurality of insulating films. For example, the insulating layer 121 may be formed of a stacked structure including an etching stopper film or the like used in forming through-holes in which the through-electrodes 146 (a second through-electrode) and 147 (a first through-electrode) to be described later are buried.

The optical structure layer 181 may include, for example, a pinning film 182, a planarization layer 183, and a microlens layer including a plurality of microlenses ML. The optical structure layer 181 may further include a filter layer. Various optical filters such as a color filter, an infrared cut filter, and a monochrome filter may be applied to the filter layer.

The semiconductor layer 131 may be provided with the elements constituting the quenching elements 32 and the waveform shaping circuits 34 of the functional blocks 30A among the constituent elements of the plurality of pixels 12. FIG. 7 illustrates a transistor provided on the side of the first face F21 of the semiconductor layer 131 as an example of the element constituting these functional blocks. Through-holes from the first face F21 to the second face F22 are provided in portions of the semiconductor layer 131 overlapping the n-type semiconductor region 112 and portions of the semiconductor layer 131 overlapping the p-type semiconductor region 116 in the plan view. Insulating members are buried in the through holes to form the insulating portions 132 including a first insulating portion 132b and a second insulating portion 132a.

The interconnection structure layer 141 may include an insulating layer 142 and one or a plurality of interconnection layers arranged in the insulating layer 142. The one or the plurality of interconnection layers includes a cathode interconnection 143 electrically connected to the n-type semiconductor region 112, an anode interconnection 144 electrically connected to the p-type semiconductor region 116, and an interconnection 145 formed of the uppermost-level interconnection layer most distant from the first face F21.

The semiconductor layer 161 may be provided with the elements constituting the selection circuits 38 and the processing circuits 36 of the functional blocks 30B among the constituent elements of the plurality of pixels 12. FIG. 7 illustrates a transistor provided on the side of the first face F31 of the semiconductor layer 161 as an example of an element constituting these functional blocks.

The interconnection structure layer 171 may include an insulating layer 172 and one or a plurality of interconnection layers arranged in the insulating layer 172. The one or the plurality of interconnection layers include the interconnection 173 formed of the uppermost-level interconnection layer most distant from the first face F31.

The sensor substrate 110 and the circuit substrate 130 are bonded to each other in a face-to-back manner such that the side of the first face F11 of the semiconductor layer 111 on which the insulating layer 121 is arranged faces the side of the second face F22 of the semiconductor layer 131 on which the insulating layer 151 is arranged. That is, the bonding face J12 between the sensor substrate 110 and the circuit substrate 130 is formed by the interface between the insulating layer 121 and the insulating layer 151. The semiconductor layer 111 and the semiconductor layer 131 are arranged so as to overlap each other, in the plan view. The electrical connection between the sensor substrate 110 and the circuit substrate 130 may be configured by through-electrodes buried in through-holes penetrating the insulating layer 142, the insulating portion 132, and the insulating layers 151 and 121. For example, the cathode interconnection 143 is electrically connected to the n-type semiconductor region 112 via the through-electrode 146. The anode interconnection 144 is electrically connected to the p-type semiconductor region 116 via the through-electrode 147.

The circuit substrate 130 and the circuit substrate 160 are bonded to each other in a face-to-face manner such that the side of the first face F21 of the semiconductor layer 131 on which the interconnection structure layer 141 is arranged faces the side of the first face F31 of the semiconductor layer 161 on which the interconnection structure layer 171 is arranged. That is, the bonding face J23 between the circuit substrate 130 and the circuit substrate 160 is formed by the interface between the interconnection structure layer 141 and the interconnection structure layer 171. The electrical connection between the circuit substrate 130 and the circuit substrate 160 may be formed by metal-metal bonding between the uppermost-level metal interconnection (interconnection 145) constituting the interconnection structure layer 141 and the uppermost-level metal interconnection (interconnection 173) constituting the interconnection structure layer 171.

As described above, the photoelectric conversion device according to the present embodiment is a so-called back-illuminated photoelectric conversion device configured to detect light incident from the side of the second face F12 which is the back surface side of the semiconductor layer 111 through the optical structure layer 181. However, the photoelectric conversion device according to the present disclosure may be configured as a photoelectric conversion device configured to detect light incident from the side of the first face F11 which is the front surface side of the semiconductor layer 111, that is, a so-called front-illuminated photoelectric conversion device.

As described above, in the photoelectric conversion device according to the present embodiment, among the constituent elements of the pixel 12, the photoelectric conversion element 22 is arranged on the sensor substrate 110, and the quenching element 32 and the waveform shaping circuit 34 are arranged on the circuit substrate 130. Then, the voltage VH is applied to the n-type semiconductor region 112, which is the cathode of the photoelectric conversion element 22, from the side of the circuit substrate 130 via the quenching element 32, the cathode interconnection 143, and the through-electrode 146. The voltage VL is applied to the p-type semiconductor region 114, which is the anode of the photoelectric conversion element 22, from the side of the circuit substrate 130 side via the anode interconnection 144, the through-electrode 147, and the p-type semiconductor region 116.

When the sensor substrate 110 and the circuit substrate 130 are bonded to each other in a face-to-back manner so that the side of the first face F11 of the semiconductor layer 111 and the side of the second face F22 of the semiconductor layer 131 face each other, the through-electrodes 146 and 147 are arranged so as to penetrate the semiconductor layer 131. At this time, in order to insulate the semiconductor layer 131 and the through-electrodes 146 and 147 from each other, through-holes are provided in portions of the semiconductor layer 131 where the through-electrodes 146 and 147 are arranged, and insulating members are buried therein, so that the insulating portion 132 is provided. In addition, the through-electrodes 146 and 147 are arranged so as to penetrate a region inside the outer peripheral portion of the insulating portion 132 in the plan view. Therefore, as the area of the insulating portion 132 in the plan view becomes larger, the area of the semiconductor layer 131 in the plan view becomes smaller, and the circuit area of the quenching elements 32 and the waveform shaping circuits 34 arranged in the semiconductor layer 131 is limited.

Therefore, in the photoelectric conversion device according to the present embodiment, the through-electrode 146 electrically connected to the cathode of the photoelectric conversion element 22 and the through-electrode 147 electrically connected to the anode of the photoelectric conversion element 22 are configured so as to penetrate through different insulating portions 132. With this configuration, the area occupied by the insulating portions 132 may be minimized, the arrangement area of the quenching elements 32 and the waveform shaping circuits 34 may be increased, and the degree of freedom in arrangement may be improved. In addition, since the through-electrode 146 and the through-electrode 147 are arranged in the different insulating portions 132, it is possible to suppress occurrence of a short circuit or dielectric breakdown between the through-electrode 146 and the through-electrode 147.

In the case where the photoelectric conversion element 22 has a rectangular shape in the plan view as illustrated in, e.g., FIG. 6A, the insulating portion 132 in which the through-electrode 146 is arranged may be arranged at a position overlapping the center portion of the rectangular shape. In addition, the insulating portion 132 in which the through-electrode 147 is arranged may be arranged at positions overlapping the corner portions of the rectangular shape. In this case, the five through-electrodes 146 and 147 may be arranged so as to penetrate through different insulating portions 132. In addition, the insulating portions 132 in which the through-electrodes 146 of the adjacent pixels 12 are arranged are provided to be isolated from each other.

When the through-electrodes 147 of the photoelectric conversion elements 22 arranged adjacent to each other are arranged close to each other, the through-electrodes 147 may be arranged so as to penetrate through one insulating portion 132. In the example of FIG. 6A, one insulating portion 132 is arranged at each position overlapping the corner portions of the four adjacent photoelectric conversion elements 22, and four through-electrodes 147 penetrate each of the insulating portions 132. With this configuration, it is possible to reduce the area of the insulating portion 132 as compared with the case where the insulating portion 132 is arranged for each through-electrode 147. Since the four through-electrodes 147 arranged in one insulating portion 132 are controlled to have the same potential, a problem does not occur even if they are short-circuited.

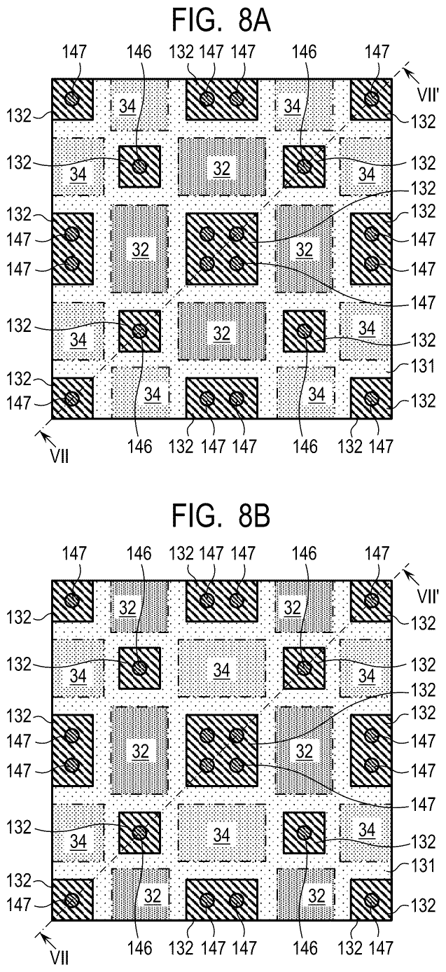

FIG. 8A and FIG. 8B are plan views illustrating arrangement examples of the quenching elements 32 and the waveform shaping circuits 34 in the semiconductor layer 131. FIG. 8A and FIG. 8B are plan views of a plane parallel to the light incident surface including the line VIB-VIB′ of FIG. 7 as viewed from the side opposite to the light incident surface.

In the circuit diagram of FIG. 3, the through-electrode 146 corresponds to a node at which the cathode of the photoelectric conversion element 22 is connected to the quenching element 32 and the waveform shaping circuit 34. That is, the through-electrode 146 is connected to each of the quenching element 32 and the waveform shaping circuit 34 via an interconnection. Therefore, when the quenching element 32 and the waveform shaping circuit 34 are arranged away from the through-electrode 146, there is a concern that the wiring distance becomes long and the parasitic capacitance of the cathode increases, and there is a possibility that the layout of the interconnections becomes complicated. Therefore, it is preferable that the quenching element 32 and the waveform shaping circuit 34 be arranged adjacent to the through-electrode 146 as illustrated in FIG. 8A and FIG. 8B, for example. By arranging the quenching elements 32 and the waveform shaping circuits 34 in this manner, it is possible to realize a reduction in parasitic capacitance and an improvement in layout efficiency.

In order to arrange the quenching element 32 and the waveform shaping circuit 34 adjacent to the through-electrode 146, one of the quenching element 32 and the waveform shaping circuit 34 may be repeatedly arranged between the through-electrodes 146 at a pixel pitch period in each of the column direction and the row direction.

In the arrangement example of FIG. 8A, in each of the column direction and the row direction, the quenching element 32 and the waveform shaping circuit 34 are alternately arranged between the through-electrodes 146 in the pixel pitch period. Thus, the through-electrode 146 is arranged between the quenching element 32 and the waveform shaping circuit 34 in both the column direction and the row direction. As a result, the through-electrode 146 may be arranged adjacent to both the quenching element 32 and the waveform shaping circuit 34.

Focusing on the through-electrodes 147, in the arrangement example of FIG. 8A, a first row in which the through-electrodes 147 surrounded on four sides by the quenching elements 32 is arranged and a second row in which the through-electrodes 147 surrounded on four sides by the waveform shaping circuits 34 is arranged are alternately arranged in the column direction. In the first row, the through-electrodes 147 surrounded by the four quenching elements 32 and the through-electrodes 147 surrounded by the two quenching elements 32 and the two waveform shaping circuits 34 are alternately arranged. In the second row, the through-electrodes 147 surrounded by the four waveform shaping circuits 34 and the through-electrodes 147 surrounded by the two quenching elements 32 and the two waveform shaping circuits 34 are alternately arranged. The column direction is also the same as the row direction described above. In a case where elements of different types are arranged adjacent to each other, for example, in a case where elements having different breakdown voltages are arranged adjacent to each other, more space may be required than in a case where elements of the same type are arranged adjacent to each other. Therefore, the layout efficiency may be improved by arranging the quenching elements 32 and the waveform shaping circuits 34 separately.

In the arrangement example of FIG. 8B, the quenching elements 32 are arranged between the through-electrodes 146 with a pixel pitch period in the column direction, and the waveform shaping circuits 34 are arranged between the through-electrodes 146 with a pixel pitch period in the row direction. In the column direction, the waveform shaping circuits 34 are arranged between the through-electrodes 147 with a pixel pitch period, and in the row direction, the quenching elements 32 are arranged between the through-electrodes 147 with a pixel pitch period. In this case, since the quenching elements 32 and the waveform shaping circuits 34 are translationally symmetric in the direction in which they are arranged, it is possible to improve the tolerance to the alignment variation.

As described above, in the present embodiment, the insulating portion 132 through which the through-electrode 146 electrically connected to the cathode of the photoelectric conversion element 22 passes and the insulating portion 132 through which the through-electrode 147 electrically connected to the anode passes are provided apart from each other. Thus, the area of the insulating portion 132 in the semiconductor layer 131 may be reduced. Therefore, according to the present embodiment, in the photoelectric conversion device including the through-electrode penetrating the semiconductor layer 131, it is possible to increase the arrangement area of the elements and circuits arranged in the semiconductor layer and to improve the degree of freedom of layout.

### Second Embodiment

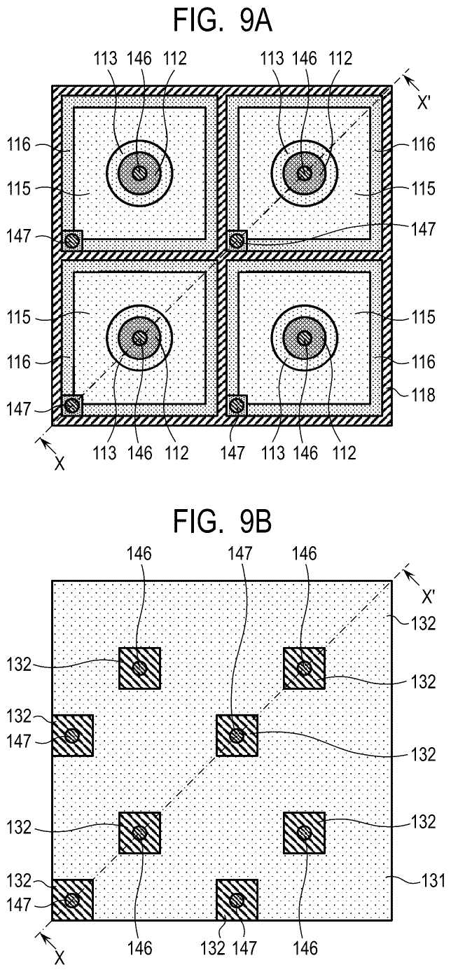

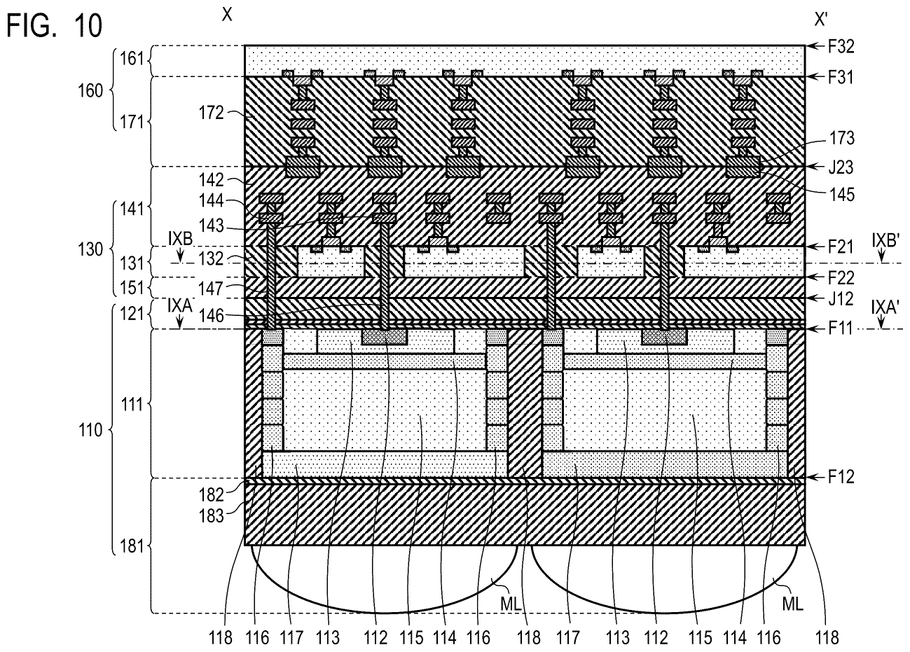

A photoelectric conversion device according to a second embodiment will be described with reference to FIG. 9A to FIG. 10. FIG. 9A and FIG. 9B are plan views illustrating a structure of a pixel in the photoelectric conversion device according to the present embodiment. FIG. 10 is a schematic cross-sectional view illustrating a structure of the pixel in the photoelectric conversion device according to the present embodiment. The same components as those of the photoelectric conversion device according to the first embodiment are denoted by the same reference numerals. For conciseness, description thereof is incorporated by reference.

FIG. 9A and FIG. 9B are plan views of four pixels 12 of 2 rows×2 columns arranged adjacent to each other among the plurality of pixels 12 constituting the pixel region 10. The direction along the line X-X′ in FIG. 9A and FIG. 9B is the diagonal direction of the pixel 12. FIG. 10 is a cross-sectional view of a plane perpendicular to the light incident surface including the line X-X′ of FIG. 9A and FIG. 9B. FIG. 9A is a plan view of a plane parallel to the light incident surface including the line IXA-IXA′ of FIG. 10, as viewed from a side opposite to the light incident surface. FIG. 9B is a plan view of a plane parallel to the light incident surface including the line IXB-IXB′ of FIG. 10, as viewed from a side opposite to the light incident surface.

As illustrated in FIG. 9A to FIG. 10, the photoelectric conversion device according to the present embodiment is different from the first embodiment in which four through-electrodes 147 are provided for one pixel 12 in that only one through-electrode 147 is provided for one pixel 12. Other features of the photoelectric conversion device according to the present embodiment may be the same as those of the first embodiment.

In the photoelectric conversion device according to the present disclosure, the through-electrodes that connect the photoelectric conversion element 22 and the functional block 30A are two types of through-electrodes, i.e., the through-electrode 146 that is electrically connected to the cathode of the photoelectric conversion element 22 and the through-electrode 147 that is electrically connected to the anode of the photoelectric conversion element 22. Therefore, at least one through-electrode 147 may be provided for one photoelectric conversion element 22. That is, the insulating portion 132 in which the through-electrode 147 is arranged may be arranged at at least one of positions overlapping four corner portions of the rectangular shape, in the plan view. By providing only two necessary through-electrodes in one pixel 12, the area of the insulating portion 132 arranged in the semiconductor layer 131 may be narrowed, the arrangement area of the quenching elements 32 and the waveform shaping circuits 34 may be further increased, and the degree of freedom in arrangement may be further improved.

In the arrangement examples of FIG. 9A and FIG. 9B, the n-type semiconductor region 112 serving as the cathode of the photoelectric conversion element 22 and the through-electrode 146 connected thereto are arranged at the center of the photoelectric conversion element 22 in the plan view, but they may be arranged so as to be shifted in a direction away from the through-electrode 147. With this configuration, the distance between the power supply position to the anode and the power supply position to the cathode may be increased to relax the electric field, and the dark count rate (DCR) caused by the strong electric field may be reduced. Note that the DCR means a generation rate of a noise signal (dark pulse) detected when there is no incident light.

As described above, according to the present embodiment, in the photoelectric conversion device including the through-electrode penetrating the semiconductor layer 131, it is possible to increase the arrangement area of the elements and circuits arranged in the semiconductor layer and to improve the degree of freedom of layout.

### Third Embodiment

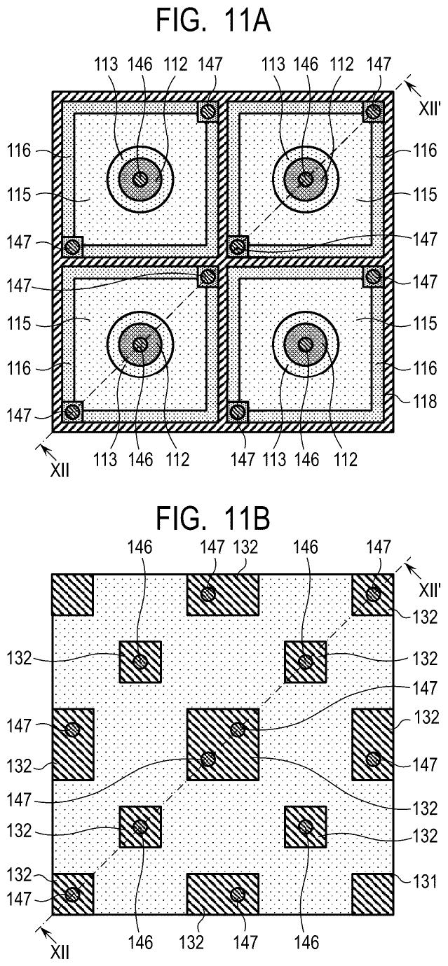

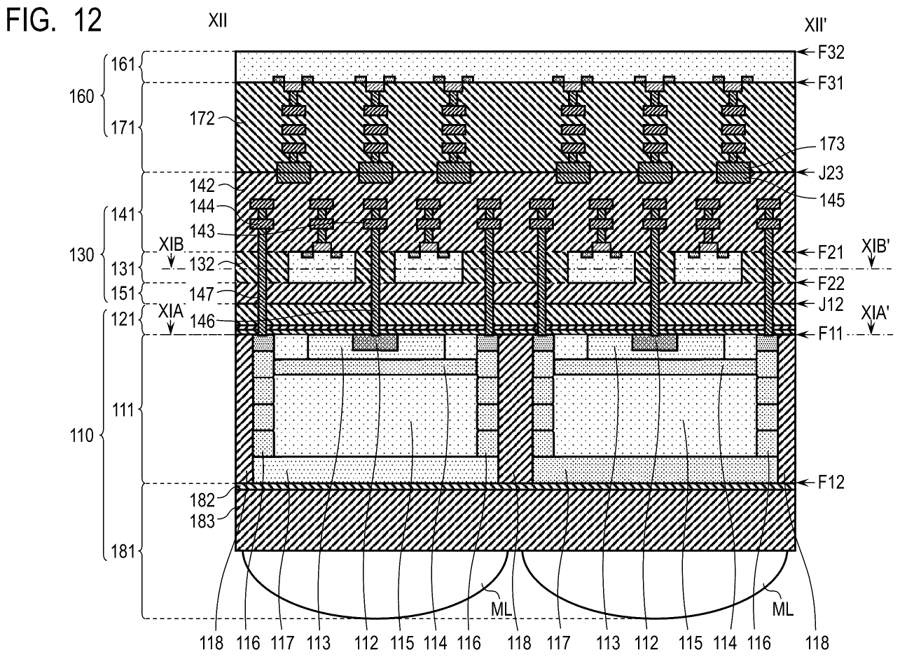

A photoelectric conversion device according to a third embodiment will be described with reference to FIG. 11A to FIG. 12. FIG. 11A and FIG. 11B are plan views illustrating a structure of a pixel in the photoelectric conversion device according to the present embodiment. FIG. 12 is a schematic cross-sectional view illustrating a structure of the pixel in the photoelectric conversion device according to the present embodiment. The same components as those of the photoelectric conversion device according to the first or second embodiment are denoted by the same reference numerals. For conciseness, description thereof is incorporated by reference.

FIG. 11A and FIG. 11B are plan views of four pixels 12 of 2 rows×2 columns arranged adjacent to each other among the plurality of pixels 12 constituting the pixel region 10. The direction along the line XII-XII′ in FIG. 11A and FIG. 11B is the diagonal direction of the pixel 12. FIG. 12 is a cross-sectional view of a plane perpendicular to the light incident surface including the line XII-XII′ of FIG. 11A and FIG. 11B. FIG. 11A is a plan view of a plane parallel to the light incident surface including the line XIA-XIA′ of FIG. 12, as viewed from a side opposite to the light incident surface. FIG. 11B is a plan view of a plane parallel to the light incident surface including the line XIB-XIB′ of FIG. 12, as viewed from a side opposite to the light incident surface.

As illustrated in FIG. 11A to FIG. 12, the photoelectric conversion device according to the present embodiment is different from the first and second embodiments in which four or one through-electrode 147 is provided for one pixel 12 in that two through-electrodes 147 are provided for one pixel 12. Other features of the photoelectric conversion device according to the present embodiment may be the same as those of the first embodiment.

By reducing the number of the through-electrodes 147 arranged in one pixel 12 from four in the first embodiment to two, the area of the insulating portion 132 arranged in the semiconductor layer 131 may be narrowed. Accordingly, the arrangement area of the quenching elements 32 and the waveform shaping circuits 34 may be further increased, and the degree of freedom in arrangement may be further improved.

Although the area of the insulating portion 132 arranged in the semiconductor layer 131 is increased as compared with the second embodiment, it is desirable to provide a plurality of through-electrodes 147 for one pixel 12 in consideration of removal of charges generated at the time of avalanche multiplication. In the present embodiment, since it is possible to secure the distance between the contacts while having the charge removal ability by arranging the two through-electrodes 147 in one pixel 12, it is advantageous to miniaturize the pixel in comparison with the first embodiment in which the four through-electrodes 147 are arranged in one pixel 12.

As described above, according to the present embodiment, in the photoelectric conversion device including the through-electrode penetrating the semiconductor layer 131, it is possible to increase the arrangement area of the elements and circuits arranged in the semiconductor layer and to improve the degree of freedom of layout.

### Fourth Embodiment

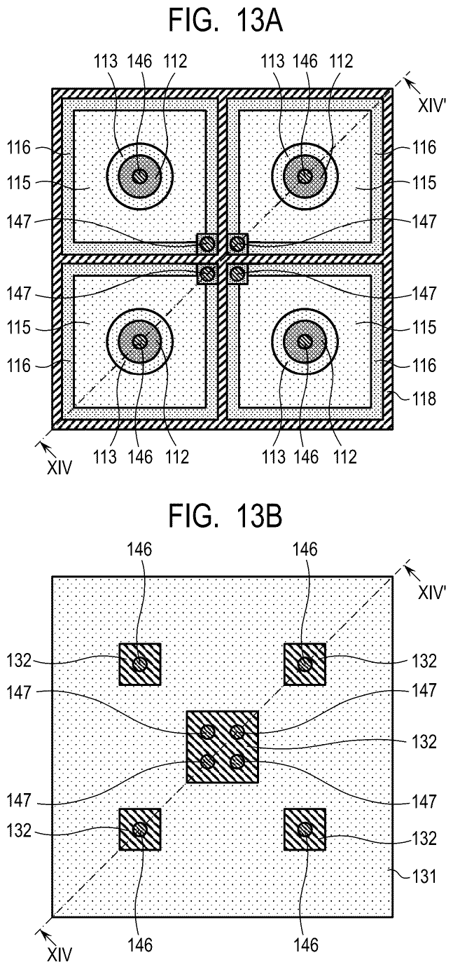

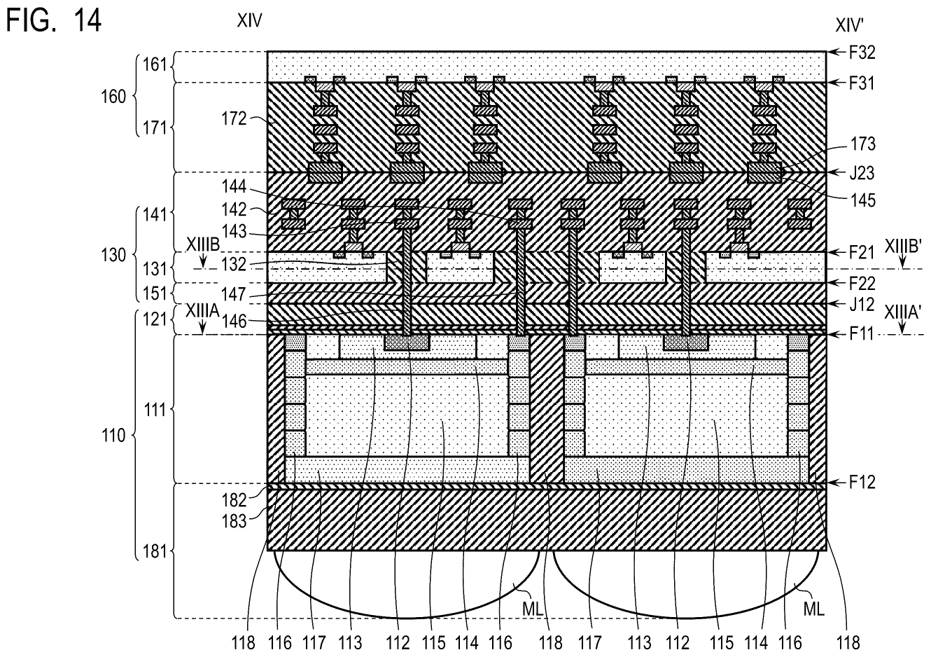

A photoelectric conversion device according to a fourth embodiment will be described with reference to FIG. 13A to FIG. 14. FIG. 13A and FIG. 13B are plan views illustrating a structure of a pixel in the photoelectric conversion device according to the present embodiment. FIG. 14 is a schematic cross-sectional view illustrating a structure of the pixel in the photoelectric conversion device according to the present embodiment. The same components as those of the photoelectric conversion devices according to the first to third embodiments are denoted by the same reference numerals. For conciseness, description thereof is incorporated by reference.

FIG. 13A and FIG. 13B are plan views of four pixels 12 of 2 rows×2 columns arranged adjacent to each other among the plurality of pixels 12 constituting the pixel region 10. The direction along the line XIV-XIV′ in FIG. 13A and FIG. 13B is the diagonal direction of the pixel 12. FIG. 14 is a cross-sectional view taken along a plane perpendicular to the light incident plane including the line XIV-XIV′ of FIG. 13A and FIG. 13B. FIG. 13A is a plan view of a plane parallel to the light incident surface including the line XIIIA-XIIIA′ of FIG. 14, as viewed from a side opposite to the light incident surface. FIG. 13B is a plan view of a plane parallel to the light incident surface including the line XIIIB-XIIIB′ of FIG. 14, as viewed from the side opposite to the light incident surface.

As illustrated in FIG. 13A to FIG. 14, the photoelectric conversion device according to the present embodiment is the same as that of the second embodiment in that only one through-electrode 147 is provided for one pixel 12, but the arrangement of the through-electrodes 147 is different from that of the second embodiment. Other features of the photoelectric conversion device according to the present embodiment may be the same as those of the first embodiment.

In the present embodiment, one insulating portion 132 arranged at a portion where the corner portions of the four photoelectric conversion elements 22 of 2 rows×2 columns are adjacent to each other is provided with the four through-electrodes 147 connected to the four photoelectric conversion elements 22. With this configuration, the area of the insulating portion 132 may be reduced as compared with the case where the insulating portion 132 is arranged for each of the through-electrodes 147. Accordingly, as compared with the second embodiment, the arrangement area of the quenching elements 32 and the waveform shaping circuits 34 may be further increased, and the degree of freedom in arrangement may be further improved.

As described above, according to the present embodiment, in the photoelectric conversion device including the through-electrode penetrating the semiconductor layer 131, it is possible to increase the arrangement area of the elements and circuits arranged in the semiconductor layer and to improve the degree of freedom of layout.

### Fifth Embodiment

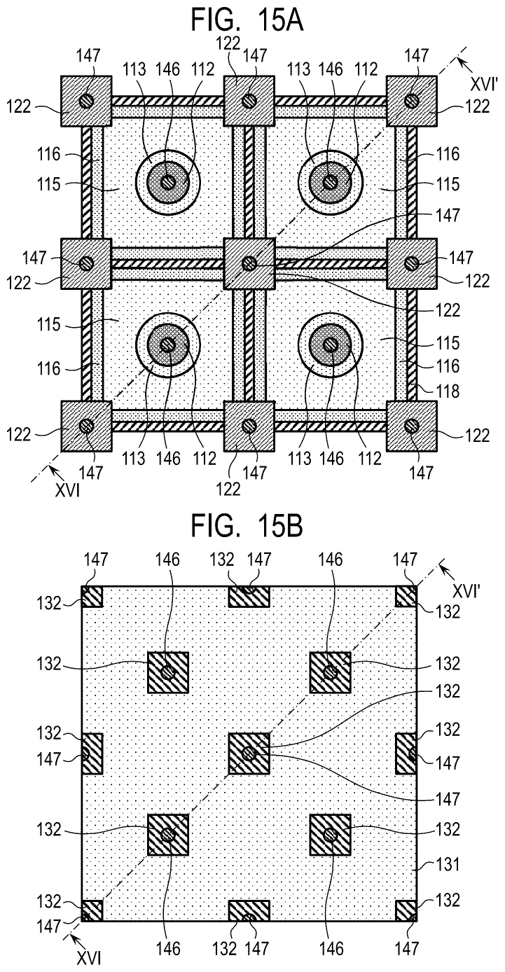

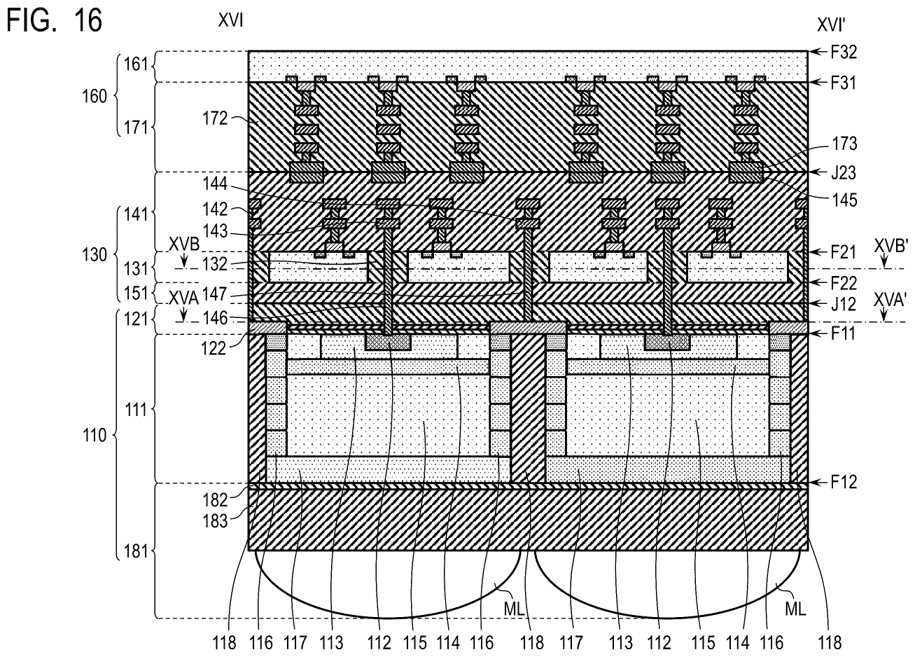

A photoelectric conversion device according to a fifth embodiment will be described with reference to FIG. 15A to FIG. 16. FIG. 15A and FIG. 15B are plan views illustrating a structure of a pixel in the photoelectric conversion device according to the present embodiment. FIG. 16 is a schematic cross-sectional view illustrating a structure of the pixel in the photoelectric conversion device according to the present embodiment. The same components as those of the photoelectric conversion devices according to the first to fourth embodiments are denoted by the same reference numerals. For conciseness, description thereof is incorporated by reference.

FIG. 15A and FIG. 15B are plan views of four pixels 12 of 2 rows×2 columns arranged adjacent to each other among the plurality of pixels 12 constituting the pixel region 10. The direction along the line XVI-XVI′ in FIG. 15A and FIG. 15B is the diagonal direction of the pixel 12. FIG. 16 is a cross-sectional view taken along a plane perpendicular to the light incident plane including the line XVI-XVI′ of FIG. 15A and FIG. 15B. FIG. 15A is a plan view of a plane parallel to the light incident surface including the line XVA-XVA′ of FIG. 16, as viewed from the side opposite to the light incident surface. FIG. 15B is a plan view of a plane parallel to the light incident surface including the line XVB-XVB′ of FIG. 16, as viewed from the side opposite to the light incident surface.

As illustrated in FIG. 15A to FIG. 16, the photoelectric conversion device according to the present embodiment further includes an interconnection 122 arranged on the first face F11 of the semiconductor layer 111. Other features of the photoelectric conversion device according to the present embodiment may be the same as those of the first embodiment.

The interconnection 122 serves as a connection portion that electrically connects the p-type semiconductor regions 116 of the adjacent photoelectric conversion elements 22. The interconnection 122 may be formed of, for example, a highly doped p-type polycrystalline silicon layer. The interconnection 122 is provided so as to be electrically connected to the p-type semiconductor regions 116 of the four photoelectric conversion elements 22 in each of portions where the corner portions of the four photoelectric conversion elements 22 are adjacent to each other in the plan view. One through-electrode 147 is electrically connected to each of the interconnections 122. That is, the voltage VL supplied to one through-electrode 147 from the side of the circuit substrate 130 via the anode interconnection 144 is applied to the p-type semiconductor regions 116 of the four photoelectric conversion elements 22 via the interconnection 122.

With this configuration, the four through-electrodes 147 are connected to one pixel 12, and the number of the through-electrodes 147 may be reduced as a whole, so that the area of the insulating portion 132 arranged in the semiconductor layer 131 may be reduced. Accordingly, the arrangement area of the quenching elements 32 and the waveform shaping circuits 34 may be further increased, and the degree of freedom in arrangement may be further improved.

Although four through-electrodes 147 are connected to one pixel 12 in the present embodiment, the number of the through-electrodes 147 connected to one pixel 12 may be appropriately changed, for example, as in the third embodiment and the fourth embodiment.

As described above, according to the present embodiment, in the photoelectric conversion device including the through-electrode penetrating the semiconductor layer 131, it is possible to increase the arrangement area of the elements and circuits arranged in the semiconductor layer and to improve the degree of freedom of layout.

### Sixth Embodiment

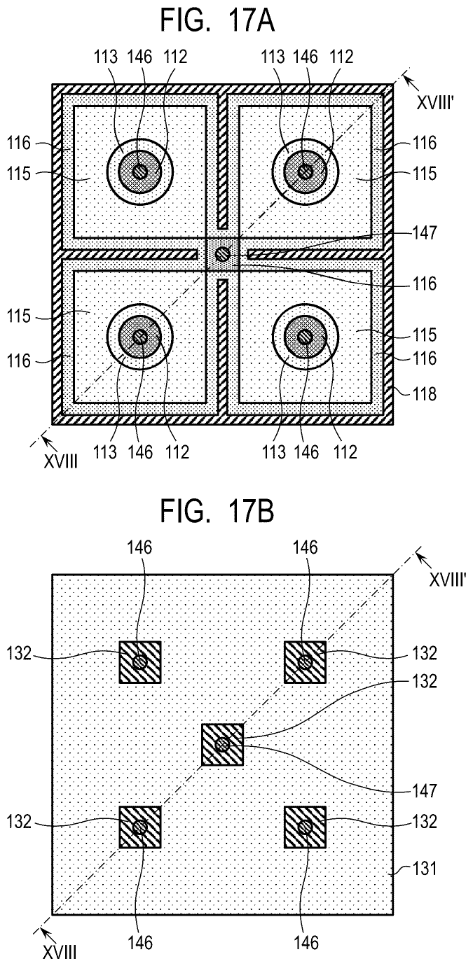

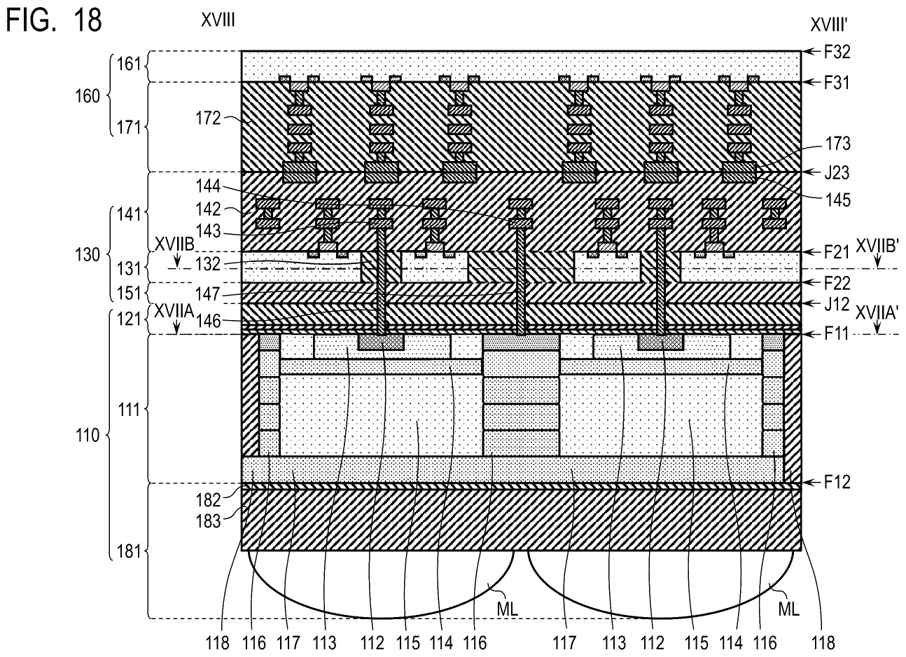

A photoelectric conversion device according to a sixth embodiment will be described with reference to FIG. 17A to FIG. 18. FIG. 17A and FIG. 17B are plan views illustrating a structure of a pixel in the photoelectric conversion device according to the present embodiment. FIG. 18 is a schematic cross-sectional view illustrating a structure of the pixel in the photoelectric conversion device according to the present embodiment. The same components as those of the photoelectric conversion devices according to the first to fifth embodiments are denoted by the same reference numerals. For conciseness, description thereof is incorporated by reference.

FIG. 17A and FIG. 17B are plan views of four pixels 12 of 2 rows×2 columns arranged adjacent to each other among the plurality of pixels 12 constituting the pixel region 10. The direction along the line XVIII-XVIII′ in FIG. 17A and FIG. 17B is the diagonal direction of the pixel 12. FIG. 18 is a cross-sectional view of a plane perpendicular to the light incident surface including the line XVIII-XVIII′ of FIG. 17A and FIG. 17B. FIG. 17A is a plan view of a plane parallel to the light incident surface including the line XVIIA-XVIIA′ of FIG. 18, as viewed from the side opposite to the light incident surface. FIG. 17B is a plan view of a plane parallel to the light incident surface including the line XVIIB-XVIIB′ of FIG. 18, as viewed from the side opposite to the light incident surface.

In the photoelectric conversion device according to the present embodiment, as illustrated in FIG. 17A to FIG. 18, the pixel isolation portion 118 is not arranged at a portion where the corner portions of the four photoelectric conversion elements 22 are adjacent to each other in the plan view. The through-electrode 147 is electrically connected to a portion of the p-type semiconductor region 116 where the pixel isolation portion 118 is not arranged. Other features of the photoelectric conversion device according to the present embodiment may be the same as those of the first embodiment.

By not arranging the pixel isolation portions 118 at portions where the corner portions of the four photoelectric conversion elements 22 are adjacent to each other, the p-type semiconductor regions 116 of the four photoelectric conversion elements 22 may be electrically connected to each other. That is, a portion of the p-type semiconductor region 116 where the pixel isolation portion 118 is not arranged has a function as a connection portion that electrically connects the p-type semiconductor regions 116 of the adjacent photoelectric conversion elements 22. Therefore, by connecting the through-electrode 147 to this portion, the voltage VL may be supplied from one through-electrode 147 to the photoelectric conversion elements 22 of the four pixels 12.

With this configuration, since the voltage VL may be supplied to the plurality of pixels 12 from one through-electrode 147, the total number of the through-electrodes 147 may be reduced, and the area of the insulating portion 132 arranged in the semiconductor layer 131 may be reduced. Accordingly, the arrangement area of the quenching element 32 and the waveform shaping circuit 34 may be further increased, and the degree of freedom in arrangement may be further improved.

Note that in the present embodiment, the pixel isolation portion 118 is not provided at all at a portion where the corner portions of the four photoelectric conversion elements 22 are adjacent to each other in the plan view, but the pixel isolation portion 118 may be provided from a position deeper than the first face F11 to the second face F12 of the semiconductor layer 111. Also in this case, since the p-type semiconductor regions 116 of the adjacent photoelectric conversion elements 22 are electrically connected to each other in the vicinity of the first face F11, it is possible to obtain the same effect as that of the present embodiment without deteriorating the isolation characteristics between the pixels 12.

Although one through-electrode 147 is connected to one pixel 12 in the present embodiment, the number of the through-electrodes 147 connected to one pixel 12 may be appropriately changed, for example, as in the third to fifth embodiments.

As described above, according to the present embodiment, in the photoelectric conversion device including the through-electrode penetrating the semiconductor layer 131, it is possible to increase the arrangement area of the elements and circuits arranged in the semiconductor layer and to improve the degree of freedom of layout.

### Seventh Embodiment

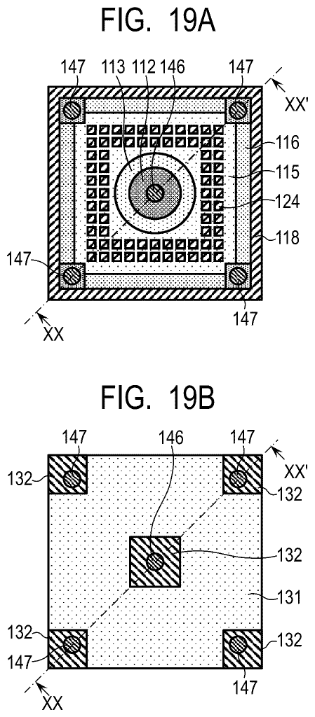

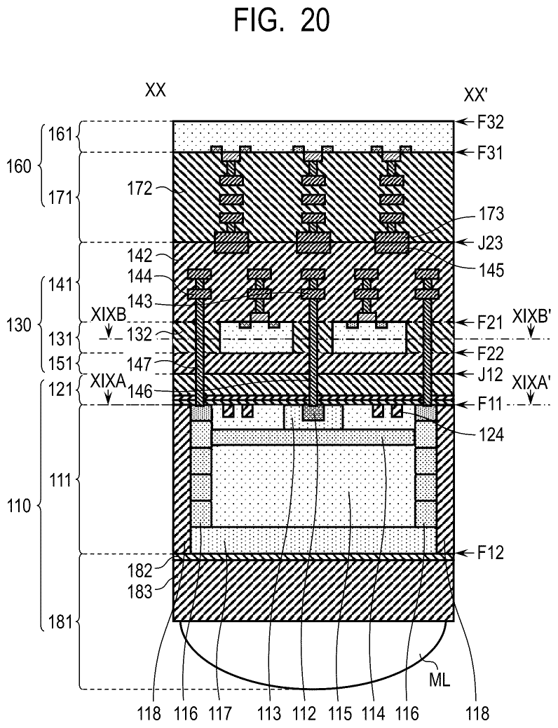

A photoelectric conversion device according to a seventh embodiment will be described with reference to FIG. 19A to FIG. 20. FIG. 19A and FIG. 19B are plan views illustrating a structure of a pixel in the photoelectric conversion device according to the present embodiment. FIG. 20 is a schematic cross-sectional view illustrating a structure of the pixel in the photoelectric conversion device according to the present embodiment. The same components as those of the photoelectric conversion devices according to the first to sixth embodiments are denoted by the same reference numerals. For conciseness, description thereof is incorporated by reference.

FIG. 19A and FIG. 19B are plan views of one pixel 12 among the plurality of pixels 12 constituting the pixel region 10. The direction along the line XX-XX′ in FIG. 19A and FIG. 19B is the diagonal direction of the pixel 12. FIG. 20 is a cross-sectional view of a plane perpendicular to the light incident surface including the line XX-XX′ of FIG. 19A and FIG. 19B. FIG. 19A is a plan view of a plane parallel to the light incident surface including the line XIXA-XIXA′ of FIG. 20 as viewed from the side opposite to the light incident surface. FIG. 19B is a plan view of a plane parallel to the light incident surface including the line XIXB-XIXB′ of FIG. 20, as viewed from the side opposite to the light incident surface.

As illustrated in FIG. 19A and FIG. 20, the photoelectric conversion device according to the present embodiment further includes a light diffusion structure 124 on the first face F11 of the semiconductor layer 111. Other features of the photoelectric conversion device according to the present embodiment may be the same as those of the first embodiment.

The light diffusion structure 124 has a function of scattering light incident on the first face F11 from the side of the second face F12 and suppressing light leaking to the side of the circuit substrate 130. The light diffusion structure 124 may be configured by, for example, a trench structure in which an insulator is buried in a groove formed in the first face F11 of the semiconductor layer 111. The light diffusion structure 124 is preferably arranged in a portion of the first face F11 that overlaps the semiconductor region (portion excluding the insulating portion 132) of the semiconductor layer 131 in the plan view. The light diffusion structure 124 has a function of scattering light incident from the side of the second face F12 of the semiconductor layer 111, and a pattern constituting the light diffusion structure 124 is not particularly limited as long as it has a function of scattering light incident from the side of the second face F12.

In the structure having the through-electrodes 146 and 147 penetrating the semiconductor layer 131 and connected to the semiconductor layer 111, it is difficult to arrange the metal interconnection in the insulating layer 121 from the viewpoint of allowing the thermal processing during manufacturing. Therefore, the light reflection layer cannot be arranged in the insulating layer 121, and there is a possibility that a decrease in near-infrared sensitivity or optical crosstalk to adjacent pixels may occur.

When light incident on the first face F11 from the side of the second face F12 leaks to the side of the circuit substrate 130, the light is reflected at the interface between the semiconductor layer 131 and the insulating layer 151 which are formed of materials having different refractive indexes. When light reflected at the interface between the semiconductor layer 131 and the insulating layer 151 propagates to the adjacent pixel 12, the light may be detected by the photoelectric conversion element 22 of the pixel 12 and cause optical crosstalk.

By providing the light diffusion structure 124 on the first face F11 of the semiconductor layer 111, light incident on the first face F11 from the side of the second face F12 may be scattered and returned to the side of the second face F12. Accordingly, light leaking to the side of the circuit substrate 130 may be reduced, and optical crosstalk to adjacent pixels may be suppressed. By arranging the light diffusion structure 124 in a portion overlapping the semiconductor region of the semiconductor layer 131 in the plan view, optical crosstalk to adjacent pixels may be suppressed more effectively.

Scattering the light incident on the first face F11 from the side of the second face F12 and returning the light to the side of the second face F12 also has an effect of increasing the optical path length for photoelectric conversion to improve sensitivity, in addition to reducing the light leaking to the side of the circuit substrate 130. In particular, a larger effect may be obtained in light of a long wavelength, for example, near-infrared light, which requires a long optical path length for photoelectric conversion.

It is desirable that the light diffusion structure 124 is located somewhat away from the avalanche multiplication region. This is because, if the light diffusion structure 124 is arranged near the avalanche multiplication region, the generation sites of the dark current may increase and the DCR may increase. From this viewpoint, it is desirable that the light diffusion structure 124 is arranged in a region that does not overlap with the n-type semiconductor regions 112 and 113. By arranging the light diffusion structure 124 in this manner, DCR may be reduced.

In the present embodiment, an example in which the light diffusion structure 124 is applied to the photoelectric conversion device according to the first embodiment has been described, but the light diffusion structure 124 may also be applied to other embodiments in the same manner as in the present embodiment.

As described above, according to the present embodiment, while the same effects as those of the first to seventh embodiments may be achieved, optical crosstalk to adjacent pixels may be suppressed, and sensitivity may be improved.

### Eighth Embodiment

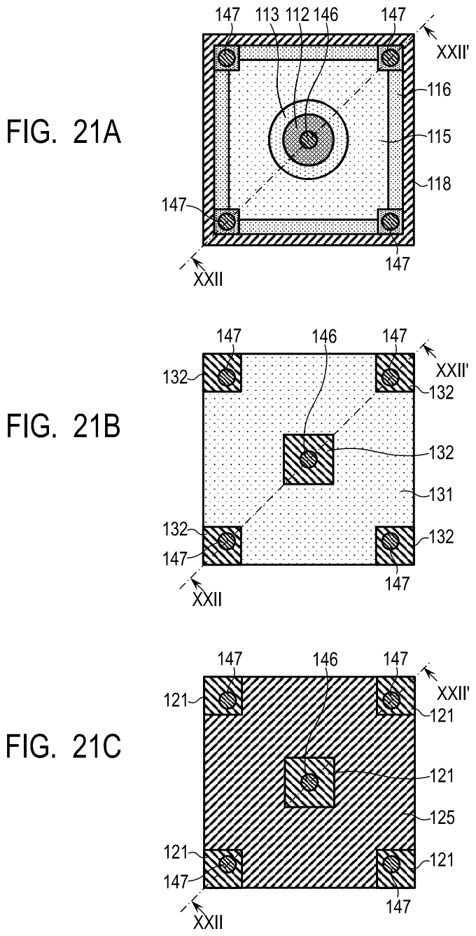

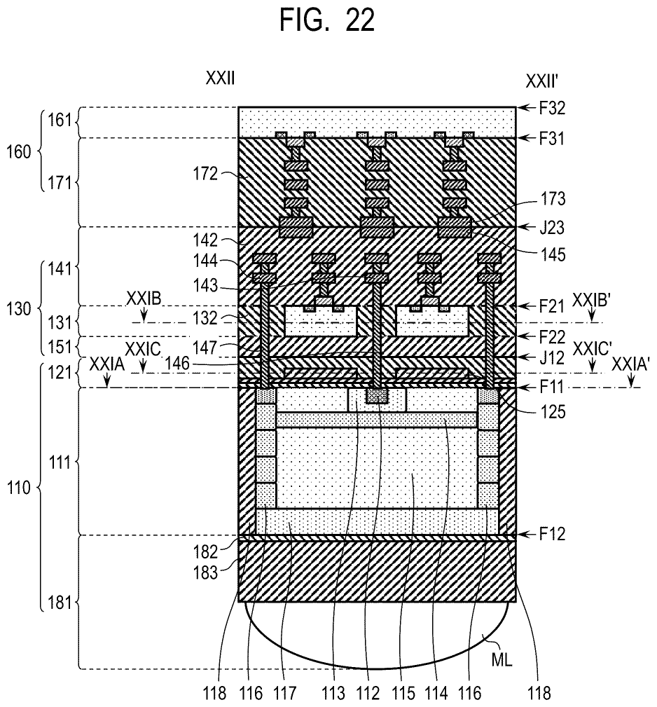

A photoelectric conversion device according to an eighth embodiment will be described with reference to FIG. 21A to FIG. 22. FIG. 21A, FIG. 21B, and FIG. 21C are plan views illustrating a structure of a pixel in the photoelectric conversion device according to the present embodiment. FIG. 22 is a schematic cross-sectional view illustrating a structure of the pixel in the photoelectric conversion device according to the present embodiment. The same components as those of the photoelectric conversion devices according to the first to seventh embodiments are denoted by the same reference numerals. For conciseness, description thereof is incorporated by reference.

FIG. 21A, FIG. 21B, and FIG. 21C are plan views of one pixel 12 among the plurality of pixels 12 constituting the pixel region 10. The direction along the line XXII-XXII′ in FIG. 21A, FIG. 21B, and FIG. 21C is the diagonal direction of the pixel 12. FIG. 22 is a cross-sectional view in a plane perpendicular to the light incident surface including the line XXII-XXII′ in FIG. 21A, FIG. 21B, and FIG. 21C. FIG. 21A is a plan view of a plane parallel to the light incident surface including the line XXIA-XXIA′ of FIG. 22, as viewed from the side opposite to the light incident surface. FIG. 21B is a plan view of a plane parallel to the light incident surface including the line XXIB-XXIB′ of FIG. 22, as viewed from the side opposite to the light incident surface. FIG. 21C is a plan view of a plane parallel to the light incident surface including the line XXIC-XXIC′ of FIG. 22, as viewed from the side opposite to the light incident surface.

As illustrated in FIG. 21C and FIG. 22, the photoelectric conversion device according to the present embodiment further includes a light reflection structure 125 in the insulating layer 121. Other features of the photoelectric conversion device according to the present embodiment may be the same as those of the first embodiment.

The light reflection structure 125 has a function of reflecting light incident on the insulating layer 121 from the side of the semiconductor layer 111 and suppressing light leaking to the side of the circuit substrate 130. The light reflection structure 125 may be formed of a dielectric material having a refractive index different from that of the insulating material forming the insulating layer 121. The light reflection structure 125 is not necessarily a single layer structure and may be a stacked structure in which a plurality of dielectric materials is stacked. The light reflection structure 125 is preferably arranged in a portion overlapping the semiconductor region (portion excluding the insulating portion 132) of the semiconductor layer 131, in the plan view.

As described above, in the structure having the through-electrodes 146 and 147 penetrating the semiconductor layer 131 and connected to the semiconductor layer 111, it is difficult to arrange the metal interconnection in the insulating layer 121, and there is a possibility that the near-infrared sensitivity is lowered and the optical crosstalk to the adjacent pixel is generated.

By providing the light reflection structure 125 in the insulating layer 121, light incident on the insulating layer 121 from the side of the semiconductor layer 111 may be reflected and returned to the side of the semiconductor layer 111. Accordingly, light leaking to the side of the circuit substrate 130 may be reduced, and optical crosstalk to adjacent pixels may be suppressed. By arranging the light reflection structure 125 in a portion overlapping the semiconductor region of the semiconductor layer 131 in the plan view, optical crosstalk to adjacent pixels may be suppressed more effectively.

In order to reflect light incident on the insulating layer 121 from the side of the semiconductor layer 111 and return the light to the side of the semiconductor layer 111, in addition to reducing light leaking to the side of the circuit substrate 130, there is also an effect of increasing the optical path length for photoelectric conversion to improve sensitivity. In particular, a larger effect may be obtained in light of a long wavelength, for example, near-infrared light, which requires a long optical path length for photoelectric conversion.

The absorptance of light in the light reflection structure 125 may be controlled by the constituent material or layer structure of the light reflection structure 125. For example, by appropriately setting the layer structure of the light reflection structure 125, the light absorptance may be suppressed to be smaller than that of the light reflection structure made of a metal material, and the sensitivity may be improved. In addition, since the wavelength at which the reflectance increases may be controlled by the layer structure of the light reflection structure 125, a layer structure in which the reflectance increases with respect to a near-infrared wavelength having a large penetration length into silicon may be applied.

As described above, in the seventh embodiment, when the light diffusion structure 124 is arranged near the avalanche multiplication region, there is a concern that the generation sites of the dark current may increase and the DCR may increase. However, in the present embodiment, since the trench is not formed in the semiconductor layer 111, the same effect as that of the seventh embodiment may be obtained without causing an increase in DCR that may occur in the seventh embodiment.

Although the light reflection structure 125 is arranged in the insulating layer 121 of the sensor substrate 110 in the present embodiment, the light reflection structure 125 may be arranged in the insulating layer 151 of the circuit substrate 130.

Further, in the present embodiment, an example in which the light reflection structure 125 is applied to the photoelectric conversion device according to the first embodiment has been described, but the light reflection structure 125 may also be applied to other embodiments in the same manner as in the present embodiment.

As described above, according to the present embodiment, while the same effects as those of the first to seventh embodiments may be achieved, optical crosstalk to adjacent pixels may be suppressed, and sensitivity may be improved.

### Ninth Embodiment

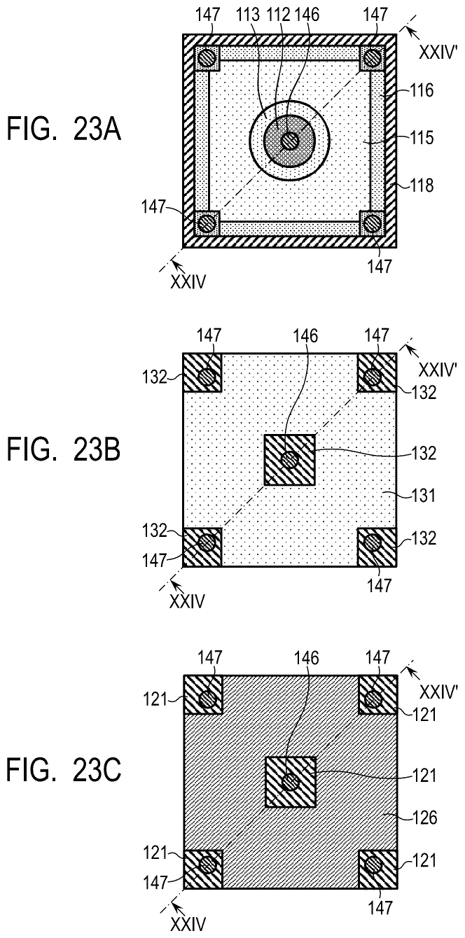

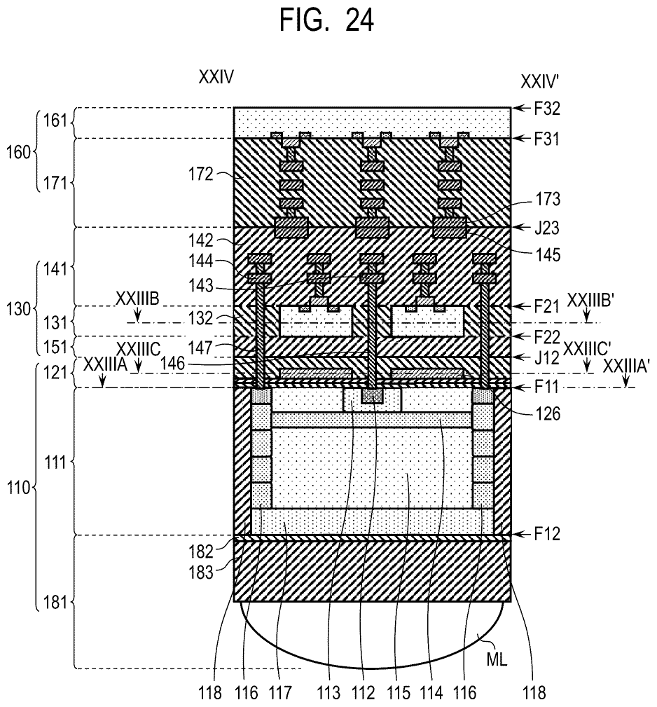

A photoelectric conversion device according to a ninth embodiment will be described with reference to FIG. 23A to FIG. 24. FIG. 23A, FIG. 23B, and FIG. 23C are plan views illustrating a structure of a pixel in the photoelectric conversion device according to the present embodiment. FIG. 24 is a schematic cross-sectional view illustrating a structure of the pixel in the photoelectric conversion device according to the present embodiment. The same components as those of the photoelectric conversion devices according to the first to eighth embodiments are denoted by the same reference numerals. For conciseness, description thereof is incorporated by reference.

FIG. 23A, FIG. 23B, and FIG. 23C are plan views of one pixel 12 among the plurality of pixels 12 constituting the pixel region 10. The direction along the line XXIV-XXIV′ in FIG. 23A, FIG. 23B, and FIG. 23C is the diagonal direction of the pixel 12. FIG. 24 is a cross-sectional view in a plane perpendicular to the light incident plane including the line XXIV-XXIV′ in FIG. 23A, FIG. 23B, and FIG. 23C. FIG. 23A is a plan view of a plane parallel to the light incident surface including the line XXIII-XXIIIA′ of FIG. 24 as viewed from the side opposite to the light incident surface. FIG. 23B is a plan view of a plane parallel to the light incident surface including the line XXIIIB-XXIIIB′ of FIG. 24 as viewed from the side opposite to the light incident surface. FIG. 23C is a plan view of a plane parallel to the light incident surface including the line XXIIIC-XXIIIC′ of FIG. 24 as viewed from the side opposite to the light incident surface.

As illustrated in FIG. 23C and FIG. 24, the photoelectric conversion device according to the present embodiment further includes a light absorption structure 126 in the insulating layer 121. Other features of the photoelectric conversion device according to the present embodiment may be the same as those of the first embodiment.

The light absorption structure 126 has a function of absorbing light incident on the insulating layer 121 from the side of the semiconductor layer 111 and suppressing light leaking to the side of the circuit substrate 130. The light absorption structure 126 may be formed of a material capable of absorbing light in a wavelength region overlapping the detection wavelength region of the photoelectric conversion element 22. The light absorption structure 126 may be formed of, for example, a polycrystalline silicon layer. The light absorption structure 126 is preferably arranged in a portion overlapping the semiconductor region (portion excluding the insulating portion 132) of the semiconductor layer 131, in the plan view.

As described above, in the structure having the through-electrodes 146 and 147 penetrating the semiconductor layer 131 and connected to the semiconductor layer 111, it is difficult to arrange the metal interconnection in the insulating layer 121, and there is a possibility that optical crosstalk to adjacent pixels occurs.

By providing the light absorption structure 126 in the insulating layer 121, light entering the insulating layer 121 from the side of the semiconductor layer 111 may be absorbed. Accordingly, light leaking to the side of the circuit substrate 130 may be reduced, and optical crosstalk to adjacent pixels may be suppressed. By arranging the light absorption structure 126 in a portion overlapping the semiconductor region of the semiconductor layer 131 in the plan view, optical crosstalk to adjacent pixels may be suppressed more effectively.

As described above, in the seventh embodiment, when the light diffusion structure 124 is arranged near the avalanche multiplication region, there is a concern that the generation sites of the dark current may increase and the DCR may increase. However, in the present embodiment, since the trench is not formed in the semiconductor layer 111, the same effect as that of the seventh embodiment may be obtained without causing an increase in DCR that may occur in the seventh embodiment.

Although the light absorption structure 126 is arranged in the insulating layer 121 of the sensor substrate 110 in the present embodiment, the light absorption structure 126 may be arranged in the insulating layer 151 of the circuit substrate 130.

Further, in the present embodiment, an example in which the light absorption structure 126 is applied to the photoelectric conversion device according to the first embodiment has been described, but the light absorption structure 126 may also be applied to other embodiments in the same manner as in the present embodiment.

As described above, according to the present embodiment, while the same effects as those of the first to seventh embodiments may be achieved, optical crosstalk to adjacent pixels may be suppressed, and sensitivity may be improved.

### Tenth Embodiment

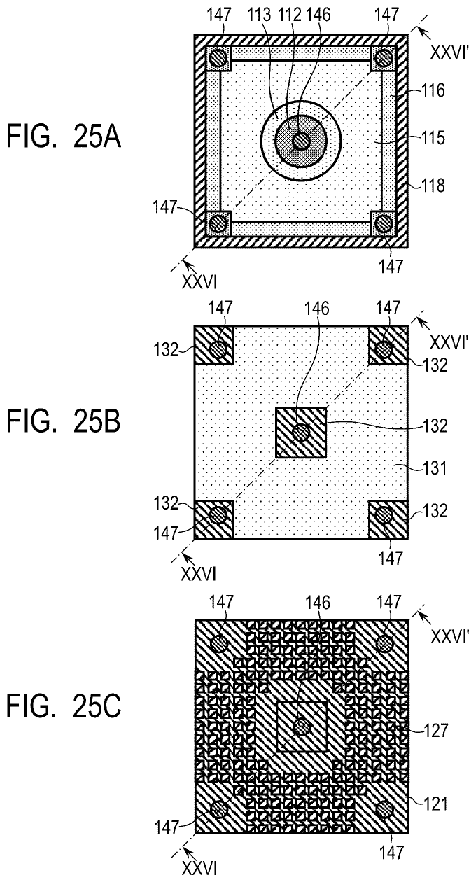

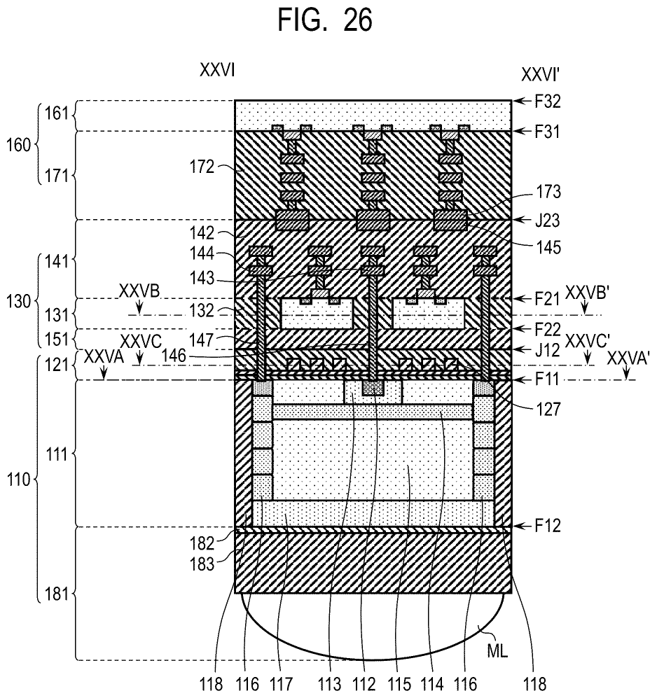

A photoelectric conversion device according to a tenth embodiment will be described with reference to FIG. 25A to FIG. 26. FIG. 25A, FIG. 25B, and FIG. 25C are plan views illustrating a structure of a pixel in the photoelectric conversion device according to the present embodiment. FIG. 26 is a schematic cross-sectional view illustrating a structure of the pixel in the photoelectric conversion device according to the present embodiment. The same components as those of the photoelectric conversion devices according to the first to ninth embodiments are denoted by the same reference numerals. For conciseness, description thereof is incorporated by reference.

FIG. 25A to FIG. 26 illustrate one pixel 12 among the plurality of pixels 12 constituting the pixel region 10. The direction along the line XXVI-XXVI′ in FIG. 25A, FIG. 25B, and FIG. 25C is the diagonal direction of the pixel 12. FIG. 26 is a cross-sectional view in a plane perpendicular to the light incident surface including the line XXVI-XXVI′ in FIG. 25A, FIG. 25B, and FIG. 25C. FIG. 25A is a plan view of a plane parallel to the light incident surface including the line XXVA-XXVA′ of FIG. 26, as viewed from the side opposite to the light incident surface. FIG. 25B is a plan view of a plane parallel to the light incident surface including the line XXVB-XXVB′ of FIG. 26 as viewed from the side opposite to the light incident surface. FIG. 25C is a plan view of a plane parallel to the light incident surface including the line XXVC-XXVC′ of FIG. 26 as viewed from the side opposite to the light incident surface.

As illustrated in FIG. 25C and FIG. 26, the photoelectric conversion device according to the present embodiment further includes a light diffusion structure 127 in the insulating layer 121. Other features of the photoelectric conversion device according to the present embodiment may be the same as those of the first embodiment.

The light diffusion structure 127 has a function of scattering light incident on the insulating layer 121 from the side of the semiconductor layer 111 and suppressing light leaking to the side of the circuit substrate 130. The light diffusion structure 127 may be configured by, for example, two-dimensionally arranging a plurality of structures made of a dielectric material having a refractive index different from that of the insulating material constituting the insulating layer 121 in the plan view. The light diffusion structure 127 is preferably arranged in a portion overlapping the semiconductor region (portion excluding the insulating portion 132) of the semiconductor layer 131, in the plan view. The light diffusion structure 127 has a function of scattering light incident on the insulating layer 121 from the side of the semiconductor layer 111, and a pattern constituting the light diffusion structure 127 is not particularly limited as long as it has a function of scattering light incident on the side of the semiconductor layer 111.

By providing the light diffusion structure 127 in the insulating layer 121, light entering the insulating layer 121 from the side of the semiconductor layer 111 may be scattered and returned to the side of the semiconductor layer 111. Accordingly, light leaking to the side of the circuit substrate 130 may be reduced, and optical crosstalk to adjacent pixels may be suppressed. By arranging the light diffusion structure 127 in a portion overlapping the semiconductor region of the semiconductor layer 131 in the plan view, optical crosstalk to adjacent pixels may be suppressed more effectively.

Scattering light incident on the insulating layer 121 from the side of the semiconductor layer 111 and returning the scattered light to the side of the semiconductor layer 111 has an effect of increasing the optical path length for photoelectric conversion to improve sensitivity, in addition to reducing light leaking to the side of the circuit substrate 130. In particular, a larger effect may be obtained in light of a long wavelength, for example, near-infrared light, which requires a long optical path length for photoelectric conversion.

As described above, in the seventh embodiment, when the light diffusion structure 124 is arranged near the avalanche multiplication region, there is a concern that the generation sites of the dark current may increase and the DCR may increase. However, in the present embodiment, since the trench is not formed in the semiconductor layer 111, the same effect as that of the seventh embodiment may be obtained without causing an increase in DCR that may occur in the seventh embodiment.

Although the light diffusion structure 127 is arranged in the insulating layer 121 of the sensor substrate 110 in the present embodiment, the light diffusion structure 127 may be arranged in the insulating layer 151 of the circuit substrate 130.

Further, in the present embodiment, an example in which the light diffusion structure 127 is applied to the photoelectric conversion device according to the first embodiment has been described, but the light diffusion structure 127 may also be applied to other embodiments in the same manner as in the present embodiment.

As described above, according to the present embodiment, while the same effects as those of the first to seventh embodiments can be achieved, optical crosstalk to adjacent pixels may be suppressed, and sensitivity may be improved.

### Eleventh Embodiment

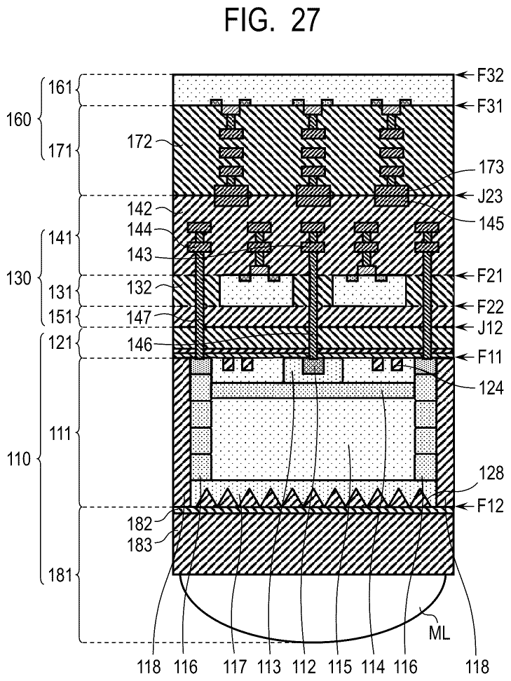

A photoelectric conversion device according to an eleventh embodiment will be described with reference to FIG. 27. FIG. 27 is a schematic cross-sectional view illustrating a structure of a pixel in the photoelectric conversion device according to the present embodiment and illustrates a cross section of one pixel in a diagonal direction. The same components as those of the photoelectric conversion devices according to the first to tenth embodiments are denoted by the same reference numerals. For conciseness, description thereof is incorporated by reference.

As illustrated in FIG. 27, the photoelectric conversion device according to the present embodiment further includes a scattering/diffraction structure 128 provided on the second face F12 of the semiconductor layer 111 in addition to the photoelectric conversion device according to the seventh embodiment. Other features of the photoelectric conversion device according to the present embodiment may be the same as those of the seventh embodiment.

The scattering/diffraction structure 128 has a function of scattering and/or diffracting light incident on the semiconductor layer 111. By providing the scattering/diffraction structure 128 on the second face F12 of the semiconductor layer 111, it is possible to increase the incident angle of light with respect to the semiconductor layer 111 and extend the optical path length in the photoelectric conversion element 22, thereby improving the sensitivity.

The scattering/diffraction structure 128 may be configured by, for example, burying an insulating member in a trench having an inverted pyramid shape or a rectangular shape formed in the second face F12 of the semiconductor layer 111. The pattern constituting the scattering/diffraction structure 128 is not particularly limited as long as it has a function of scattering and/or diffracting light incident from the second face F12. The scattering/diffraction structure 128 is preferably provided in a region shallower than the p-type semiconductor region 117 when viewed from the side of the second face F12.

In the present embodiment, an example in which the scattering/diffraction structure 128 is applied to the photoelectric conversion device according to the seventh embodiment has been described, but the scattering/diffraction structure 128 may be applied to other embodiments as in the present embodiment.

As described above, according to the present embodiment, while the same effects as those of the first to seventh embodiments may be achieved, optical crosstalk to adjacent pixels may be suppressed, and sensitivity may be improved.

### Twelfth Embodiment

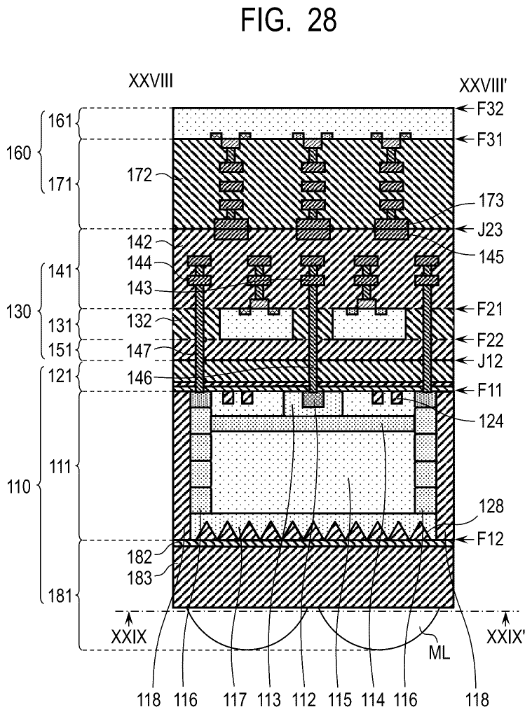

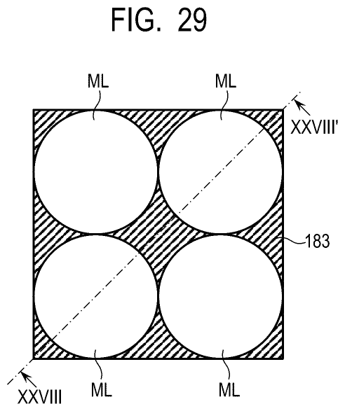

A photoelectric conversion device according to a twelfth embodiment will be described with reference to FIG. 28 and FIG. 29. FIG. 28 is a schematic cross-sectional view illustrating a structure of a pixel in the photoelectric conversion device according to the present embodiment and illustrates a cross section of one pixel in a diagonal direction. FIG. 29 is a plan view illustrating a structure of the pixel in the photoelectric conversion device according to the present embodiment. The same components as those of the photoelectric conversion devices according to the first to eleventh embodiments are denoted by the same reference numerals. For conciseness, description thereof is incorporated by reference.

FIG. 28 and FIG. 29 illustrate one pixel 12 among the plurality of pixels 12 constituting the pixel region 10. The direction along the line XXVIII-XXVIII′ in FIG. 29 is the diagonal direction of the pixel 12. FIG. 28 is a cross-sectional view of a plane perpendicular to the light incident surface including the line XXVIII-XXVIII′ in FIG. 29. FIG. 29 is a plan view of a plane parallel to the light incident surface including the line XXIX-XXIX′ of FIG. 28, as viewed from the side of the light incident surface.

As illustrated in FIG. 28, the photoelectric conversion device according to the present embodiment includes a microlens array including two or more microlenses ML for each pixel 12. Specifically, four microlenses ML are arranged for one pixel 12. As illustrated in FIG. 29, the four microlenses ML are arranged in a matrix of two rows and two columns in the plan view.

By arranging a plurality of microlenses ML for one photoelectric conversion element 22, similarly to the eleventh embodiment, the incident angle of light with respect to the semiconductor layer 111 may be increased to extend the optical path length in the photoelectric conversion element 22. Further, by further arranging the scattering/diffraction structure 128, the scattering effect on the side of the second face F12 may be further enhanced, and the optical path length in the photoelectric conversion element 22 may be further extended. Accordingly, the sensitivity of the photoelectric conversion element 22 may be improved.

In the present embodiment, an example in which the plurality of microlenses ML is applied to one pixel 12 in the photoelectric conversion device according to the eleventh embodiment has been described, but the same configuration as that of the present embodiment may also be applied to other embodiments.

As described above, according to the present embodiment, while the same effects as those of the first to seventh embodiments may be achieved, optical crosstalk to adjacent pixels may be suppressed, and sensitivity may be improved.

### Thirteenth Embodiment

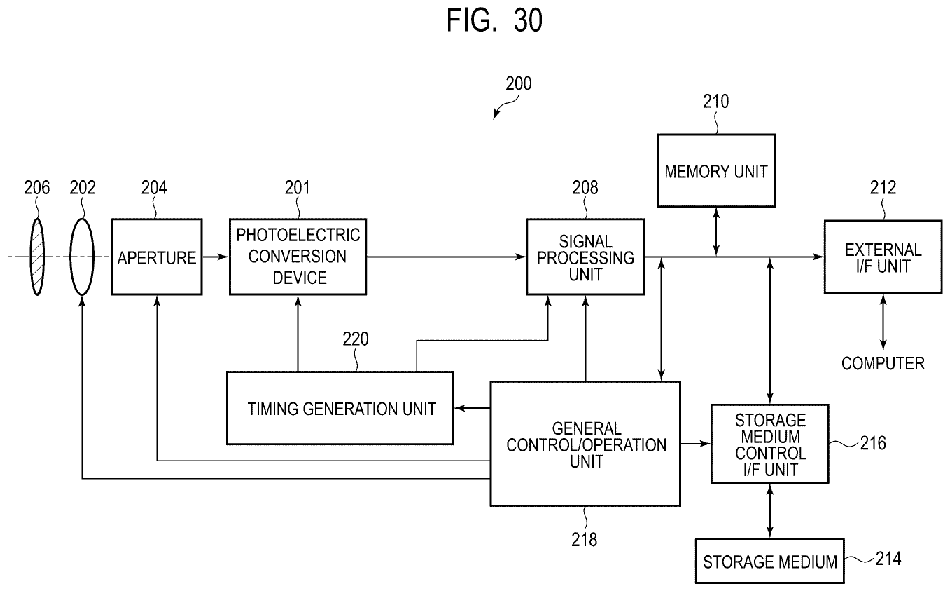

A photodetection system according to a thirteenth embodiment will be described with reference to FIG. 30. FIG. 30 is a block diagram illustrating a schematic configuration of a photodetection system according to the present embodiment. In the present embodiment, a photodetection sensor to which the photoelectric conversion device 100 according to any one of the first to twelfth embodiments is applied will be described.

The photoelectric conversion device 100 described in the first to twelfth embodiments may be applied to various photodetection systems. Examples of applicable photodetection systems include imaging systems such as digital still cameras, digital camcorders, surveillance cameras, copying machines, facsimiles, mobile phones, on-vehicle cameras, observation satellites, and the like. A camera module including an optical system such as a lens and an imaging device is also included in the photodetection system. FIG. 30 exemplifies a block diagram of a digital still camera as one of these.

The photodetection system 200 illustrated in FIG. 30 includes a photoelectric conversion device 201, a lens 202 that forms an optical image of an object on the photoelectric conversion device 201, an aperture 204 for varying the amount of light passing through the lens 202, and a barrier 206 for protecting the lens 202. The lens 202 and the aperture 204 constitute an optical system that focuses light onto the photoelectric conversion device 201. The photoelectric conversion device 201 is the photoelectric conversion device 100 described in any one of the first to twelfth embodiments and converts the optical image formed by the lens 202 into image data.

The photodetection system 200 further includes a signal processing unit 208 that processes an output signal output from the photoelectric conversion device 201. The signal processing unit 208 generates image data from the digital signal output from the photoelectric conversion device 201. Further, the signal processing unit 208 performs various corrections and compressions as necessary and outputs the processed image data. The photoelectric conversion device 201 may include an analog-to-digital (AD) conversion unit that generates a digital signal to be processed by the signal processing unit 208. The AD conversion unit may be formed on a semiconductor layer (semiconductor substrate) on which the photoelectric conversion element of the photoelectric conversion device 201 is formed or may be formed on a semiconductor layer different from the semiconductor layer on which the photoelectric conversion element of the photoelectric conversion device 201 is formed. The signal processing unit 208 may be formed on the same semiconductor layer as the photoelectric conversion device 201.

The photodetection system 200 further includes a memory unit 210 for temporarily storing image data and an external interface unit (external I/F unit) 212 for communicating with an external computer or the like. Further, the photodetection system 200 includes a storage medium 214 such as a semiconductor memory for performing storing or reading out of imaging data, and a storage medium control interface unit (storage medium control I/F unit) 216 for performing storing on or reading out from the storage medium 214. The storage medium 214 may be built in the photodetection system 200 or may be detachable. Communication between the storage medium control I/F unit 216 and the storage medium 214 and communication from the external I/F unit 212 may be performed wirelessly.

The photodetection system 200 further includes a general control/operation unit 218 that performs various calculations and controls the entire digital still camera, and a timing generation unit 220 that outputs various timing signals to the photoelectric conversion device 201 and the signal processing unit 208. Here, the timing signal or the like may be input from the outside, and the photodetection system 200 may include at least the photoelectric conversion device 201 and the signal processing unit 208 that processes the output signal output from the photoelectric conversion device 201. The timing generation unit 220 may be mounted on the photoelectric conversion device 201. Further, the general control/operation unit 218 and the timing generation unit 220 may be configured to perform a part or all of the control functions of the photoelectric conversion device 201.

The photoelectric conversion device 201 outputs an imaging signal to the signal processing unit 208. The signal processing unit 208 performs predetermined signal processing on the imaging signal output from the photoelectric conversion device 201 and outputs image data. The signal processing unit 208 generates an image using the imaging signal. The signal processing unit 208 may be configured to perform distance measurement calculation on the signal output from the photoelectric conversion device 201.

As described above, according to the present embodiment, by configuring the photodetection system using the photoelectric conversion device according to any one of the first to twelfth embodiments, it is possible to realize the photodetection system capable of acquiring a higher quality image.

### Fourteenth Embodiment

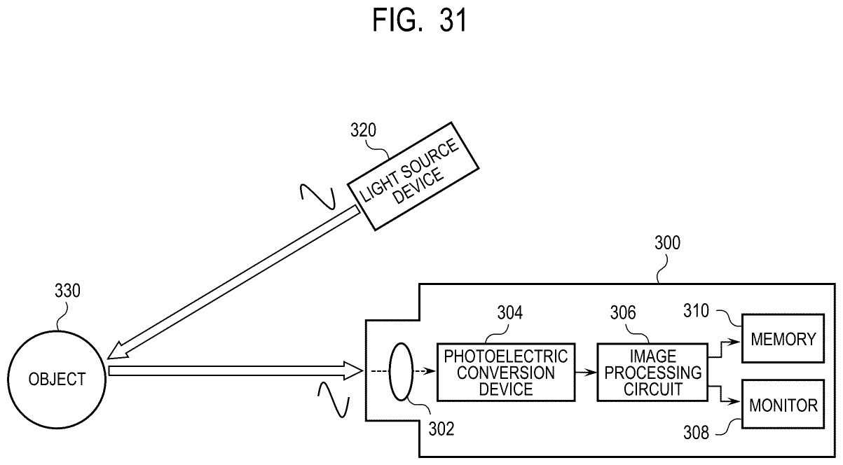

A range image sensor according to a fourteenth embodiment will be described with reference to FIG. 31. FIG. 31 is a block diagram illustrating a schematic configuration of a range image sensor according to the present embodiment. In the present embodiment, a range image sensor will be described as an example of a photodetection system to which the photoelectric conversion device 100 according to any one of the first to twelfth embodiments is applied.

As illustrated in FIG. 31, the range image sensor 300 according to the present embodiment may include an optical system 302, a photoelectric conversion device 304, an image processing circuit 306, a monitor 308, and a memory 310. The range image sensor 300 receives light (modulated light or pulsed light) emitted from the light source device 320 toward an object 330 and reflected on the surface of the object 330, and acquires a distance image corresponding to the distance to the object 330.

The optical system 302 includes one or a plurality of lenses and has a function of forming an image of image light (incident light) from the object 330 on a light receiving surface (sensor unit) of the photoelectric conversion device 304.

The photoelectric conversion device 304 is the photoelectric conversion device 100 described in any one of the first to twelfth embodiments and has a function of generating a distance signal indicating a distance to the object 330 based on image light from the object 330 and supplying the generated distance signal to the image processing circuit 306.

The image processing circuit 306 has a function of performing image processing for constructing a distance image based on the distance signal supplied from the photoelectric conversion device 304.

The monitor 308 has a function of displaying a distance image (image data) obtained by image processing in the image processing circuit 306. The memory 310 has a function of storing (recording) a distance image (image data) obtained by image processing in the image processing circuit 306.

As described above, according to the present embodiment, by configuring the range image sensor using the photoelectric conversion devices according to any one of the first to twelfth embodiments, it is possible to realize a range image sensor capable of acquiring a range image including more accurate range information in conjunction with improvement in characteristics of the pixels 12.

### Fifteenth Embodiment

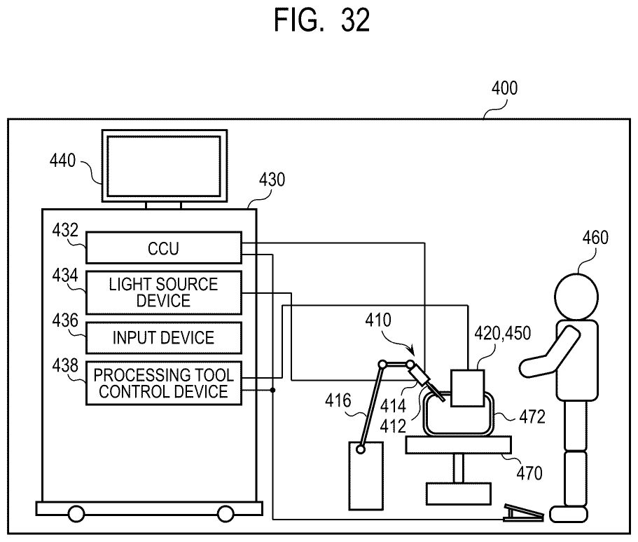

An endoscopic surgical system according to a fifteenth embodiment will be described with reference to FIG. 32. FIG. 32 is a schematic diagram illustrating a configuration example of an endoscopic surgical system according to the present embodiment. In the present embodiment, an endoscopic surgical system will be described as an example of a photodetection system to which the photoelectric conversion device 100 according to any one of the first to twelfth embodiments is applied.

FIG. 32 illustrates a state in which an operator (surgeon) 460 performs surgery on a patient 472 on a patient bed 470 using an endoscopic surgical system 400.

As illustrated in FIG. 32, the endoscopic surgical system 400 according to the present embodiment may include an endoscope 410, a surgical tool 420, and a cart 430 on which various devices for endoscopic surgery are mounted. A camera control unit (CCU) 432, a light source device 434, an input device 436, a processing tool control device 438, a display device 440, and the like may be mounted on the cart 430.

The endoscope 410 includes a lens barrel 412 in which an area of a predetermined length from the tip is inserted into a body cavity of the patient 472, and a camera head 414 connected to the base end of the lens barrel 412. Although FIG. 32 illustrates an endoscope 410 configured as a so-called rigid mirror having a rigid lens barrel 412, the endoscope 410 may be configured as a so-called flexible mirror having a flexible lens barrel. The endoscope 410 is held in a movable state by an arm 416.

The tip of the lens barrel 412 is provided with an opening into which an objective lens is fitted. A light source device 434 is connected to the endoscope 410, and light generated by the light source device 434 is guided to the tip of the lens barrel 412 by a light guide extended inside the lens barrel and is irradiated toward an observation target in the body cavity of the patient 472 through the objective lens. Note that the endoscope 410 may be a direct-viewing mirror, an oblique-viewing mirror, or a side-viewing mirror.

An optical system and a photoelectric conversion device are provided inside the camera head 414, and reflected light (observation light) from the observation target is focused on the photoelectric conversion device by the optical system. The photoelectric conversion device photoelectrically converts the observation light and generates an electrical signal corresponding to the observation light, that is, an image signal corresponding to the observation image. As the photoelectric conversion device, the photoelectric conversion device 100 described in any one of the first to twelfth embodiments may be used. The image signal is transmitted to the CCU 432 as RAW data.

The CCU 432 may be configured by a central processing unit (CPU), a graphics processing unit (GPU), or the like, and integrally controls operations of the endoscope 410 and the display device 440. Further, the CCU 432 receives an image signal from the camera head 414 and performs various types of image processing for displaying an image based on the image signal, such as development processing (demosaic processing), on the image signal.

The display device 440 displays an image based on the image signal subjected to the image processing by the CCU 432 under the control of the CCU 432.

The light source device 434 may be configured by, for example, a light source such as a light emitting diode (LED) and supplies irradiation light to the endoscope 410 when photographing a surgical part or the like.

The input device 436 is an input interface to the endoscopic surgical system 400. The user may input various kinds of information and input instructions to the endoscopic surgical system 400 via the input device 436.

The processing tool control device 438 controls the driving of the energy processing tool 450 for tissue ablation, incision, blood vessel sealing, or the like.

The light source device 434 that supplies irradiation light to the endoscope 410 when imaging the surgical part may be configured by, for example, a white light source configured by an LED, a laser light source, or a combination thereof. When the white light source is configured by a combination of the RGB laser light sources, since the output intensity and the output timing of each color (each wavelength) may be controlled with high accuracy, the white balance of the captured image may be adjusted in the light source device 434. In addition, in this case, it is also possible to capture an image corresponding to each of RGB in a time division manner by irradiating the observation target with laser light from each of the RGB laser light sources in a time division manner and controlling driving of the imaging element of the camera head 414 in synchronization with the irradiation timing. According to this method, a color image may be obtained without providing a color filter in the image sensor.

Further, the driving of the light source device 434 may be controlled so as to change the intensity of light to be output every predetermined time. By controlling the driving of the image sensor of the camera head 414 in synchronization with the timing of the change of the intensity of the light to acquire an image in a time-division manner and compositing the image, it is possible to generate an image having a high dynamic range free from so-called blacked up shadows and blown out highlights.

The light source device 434 may be configured to be capable of supplying light in a predetermined wavelength band corresponding to special light observation. In the special light observation, for example, wavelength dependency of absorption of light in body tissue is utilized. Specifically, a predetermined tissue such as a blood vessel in the superficial layer of a mucous membrane is photographed with high contrast by irradiating light in a narrow band as compared with irradiation light (that is, white light) at the time of normal observation. Alternatively, in the special light observation, fluorescence observation in which an image is obtained by fluorescence generated by irradiation with excitation light may be performed. In the fluorescence observation, a body tissue is irradiated with excitation light to observe fluorescence from the body tissue, or a body tissue is locally injected with a reagent such as indocyanine green (ICG), and the body tissue is irradiated with excitation light corresponding to a fluorescence wavelength of the reagent to obtain a fluorescence image. The light source device 434 may be configured to be capable of supplying narrowband light and/or excitation light corresponding to such special light observation.

As described above, according to the present embodiment, by configuring the endoscopic surgical system using the photoelectric conversion device according to any one of the first to twelfth embodiments, it is possible to realize an endoscopic surgical system capable of acquiring a better quality image.

### Sixteenth Embodiment

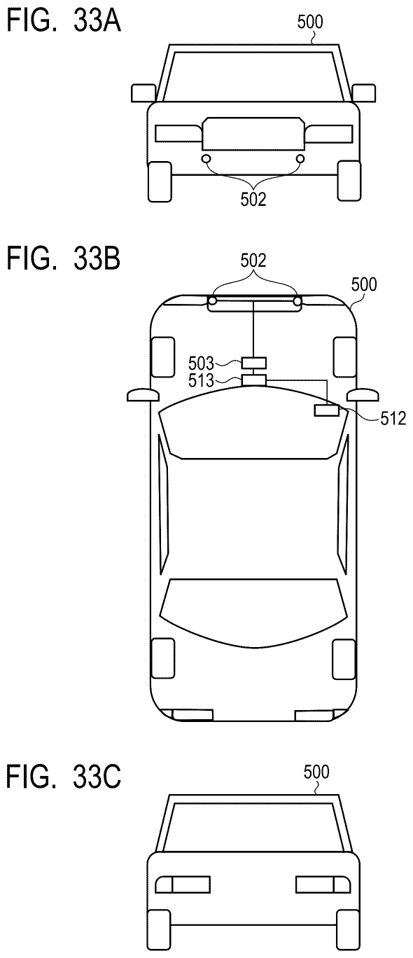

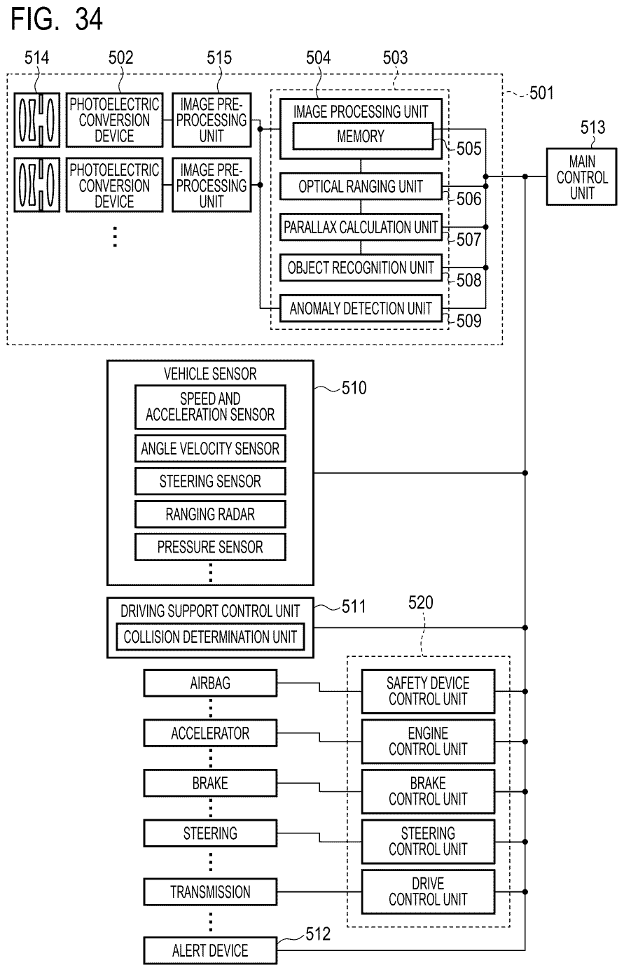

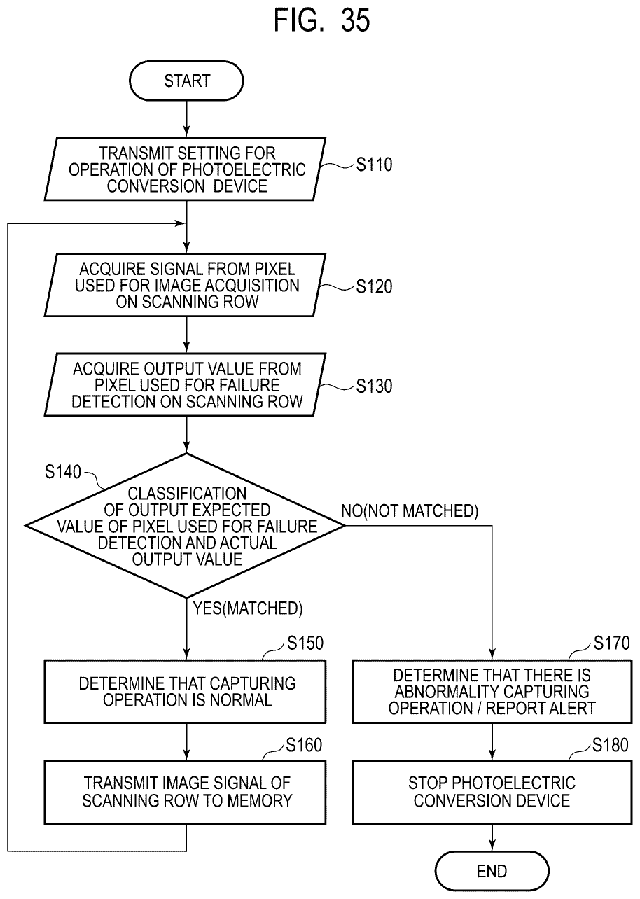

A photodetection system and a movable object according to a sixteenth embodiment will be described with reference to FIG. 33A to FIG. 35. FIG. 33A, FIG. 33B, and FIG. 33C are schematic diagrams illustrating a configuration example of a movable object according to the present embodiment. FIG. 34 is a block diagram illustrating a schematic configuration of a photodetection system according to the present embodiment. FIG. 35 is a flowchart illustrating an operation of the photodetection system according to the present embodiment. In the present embodiment, an application example to an on-vehicle camera will be described as a photodetection system to which the photoelectric conversion device 100 according to any one of the first to twelfth embodiments is applied.

FIG. 33A, FIG. 33B, and FIG. 33C are schematic diagrams illustrating a configuration example of a movable object (vehicle system) according to the present embodiment. FIG. 33A, FIG. 33B, and FIG. 33C illustrate a configuration of a vehicle 500 (automobile) as an example of a vehicle system incorporating a photodetection system to which the photoelectric conversion device according to any one of the first to twelfth embodiments is applied. FIG. 33A is a schematic front view of the vehicle 500, FIG. 33B is a schematic plan view of the vehicle 500, and FIG. 33C is a schematic rear view of the vehicle 500. The vehicle 500 includes a pair of photoelectric conversion devices 502 on a front face thereof. Here, the photoelectric conversion device 502 is the photoelectric conversion device 100 described in any one of the first to twelfth embodiments. The vehicle 500 includes an integrated circuit 503, an alert device 512, and a main control unit 513.

FIG. 34 is a block diagram illustrating a configuration example of the photodetection system 501 mounted on the vehicle 500. The photodetection system 501 includes photoelectric conversion devices 502, image preprocessing units 515, an integrated circuit 503, and optical systems 514. The photoelectric conversion device 502 is the photoelectric conversion device 100 described in any one of the first to twelfth embodiments. The optical system 514 forms an optical image of an object on the photoelectric conversion device 502. The photoelectric conversion device 502 converts the optical image of the object formed by the optical system 514 into an electrical signal. The image preprocessing unit 515 performs predetermined signal processing on the signal output from the photoelectric conversion device 502. The function of the image preprocessing unit 515 may be incorporated in the photoelectric conversion device 502. At least two sets of the optical system 514, the photoelectric conversion device 502, and the image preprocessing unit 515 are provided in the photodetection system 501, and an output from the image processing unit 515 of each set is input to the integrated circuit 503.

The integrated circuit 503 is an integrated circuit for an imaging system application and includes an image processing unit 504, an optical ranging unit 506, a parallax calculation unit 507, an object recognition unit 508, and an abnormality detection unit 509. The image processing unit 504 processes the image signal output from the image preprocessing unit 515. For example, the image processing unit 504 performs image processing such as development processing and defect correction on the output signal of the image preprocessing unit 515. The image processing unit 504 includes a memory 505 that temporarily holds the image signal. In the memory 505, for example, the position of a known defective pixel in the photoelectric conversion device 502 may be stored.

The optical ranging unit 506 performs focusing and distance measurement of the object. The parallax calculation unit 507 calculates distance measurement information (distance information) from a plurality of image data (parallax images) acquired by the plurality of photoelectric conversion devices 502. Each of the photoelectric conversion devices 502 may have a configuration capable of acquiring various kinds of information such as distance information. The object recognition unit 508 recognizes an object such as a vehicle, a road, a sign, or a person. Upon detecting an abnormality in the photoelectric conversion device 502, the abnormality detection unit 509 notifies the main control unit 513 of the abnormality.

The integrated circuit 503 may be realized by dedicatedly designed hardware, may be realized by a software module, or may be realized by a combination thereof. Further, it may be realized by a field programmable gate array (FPGA), an application specific integrated circuit (ASIC), or the like, or may be realized by a combination of these.

The main control unit 513 integrally controls the operations of the photodetection system 501, the vehicle sensor 510, the control unit 520, and the like. The vehicle 500 may not include the main control unit 513. In this case, the photoelectric conversion device 502, the vehicle sensor 510, and the control unit 520 transmit and receive control signals via a communication network. For example, the controller area network (CAN) standard may be applied to the transmission and reception of the control signals.

The integrated circuit 503 has a function of receiving a control signal from the main control unit 513 or transmitting a control signal or a setting value to the photoelectric conversion device 502 by its own control unit.

The photodetection system 501 is connected to the vehicle sensor 510 and may detect a traveling state of the host vehicle such as a vehicle speed, a yaw rate, and a steering angle, an environment outside the host vehicle, and states of other vehicles and obstacles. The vehicle sensor 510 is also a distance information acquisition unit that acquires distance information to the object. In addition, the photodetection system 501 is connected to a driving support control unit 511 that performs various kinds of driving support such as automatic steering, automatic traveling, and a collision prevention function. In particular, with respect to the collision determination function, the driving support control unit 511 estimates the collision with other vehicles or obstacles and determines whether or not there is a collision with other vehicles or obstacles based on the detection results of the photodetection system 501 and the vehicle sensor 510. Thus, avoidance control when a collision is estimated and activation of the safety device at the time of the collision are performed.

The photodetection system 501 is also connected to an alert device 512 that issues an alert to the driver based on the determination result of the collision determination unit. For example, when the determination result of the collision determination unit is that the possibility of a collision is high, the main control unit 513 performs vehicle control for avoiding a collision and reducing damage by applying a brake, returning an accelerator, suppressing engine output, or the like. The alert device 512 alerts the user by sounding an alarm such as a sound, displaying alert information on a display screen of a car navigation system, a meter panel, or the like, or vibrating a seat belt or a steering wheel.

In the present embodiment, an image of the surroundings of the vehicle, for example, the front or the rear, is captured by the photodetection system 501. FIG. 33B illustrates an arrangement example of the photodetection system 501 in a case where the photodetection system 501 captures an image in front of the vehicle.

As described above, the photoelectric conversion device 502 is disposed in front of the vehicle 500. Specifically, it is preferable that a center line with respect to an advancing/retreating direction or an outer shape (for example, a vehicle width) of the vehicle 500 is regarded as a symmetry axis, and two photoelectric conversion devices 502 are disposed line-symmetrically with respect to the symmetry axis in order to acquire distance information between the vehicle 500 and an object to be imaged and determine a possibility of collision. In addition, the photoelectric conversion devices 502 are preferably disposed so as not to interfere with the driver's visual field when the driver visually recognizes a situation outside the vehicle 500 from the driver's seat. The alert device 512 is preferably disposed so as to easily enter the field of view of the driver.

Next, a failure detection operation of the photoelectric conversion device 502 in the photodetection system 501 will be described with reference to FIG. 35. The failure detection operation of the photoelectric conversion device 502 may be performed in accordance with steps S110 to S180 illustrated in FIG. 35.

Step S110 is a step of performing setting at the time of start-up of the photoelectric conversion device 502. That is, the setting for the operation of the photoelectric conversion device 502 is transmitted from the outside of the photodetection system 501 (for example, the main control unit 513) or the inside of the photodetection system 501, and the imaging operation and the failure detection operation of the photoelectric conversion device 502 are started.

Next, in step S120, pixel signals are acquired from the effective pixels. In step S130, an output value from a failure detection pixel provided for failure detection is acquired. The failure detection pixel may include a photoelectric conversion element in the same manner as the effective pixel. A predetermined voltage is written to the photoelectric conversion element of the failure detection pixel. The failure detection pixel outputs a signal corresponding to the voltage written in the photoelectric conversion element. Note that step S120 and step S130 may be reversed.

Next, in step S140, a classification of the output expected value of the failure detection pixel and the actual output value from the failure detection pixel is performed. As a result of the classification in step S140, when the output expected value matches the actual output value, the process proceeds to step S150, it is determined that the imaging operation is normally performed, and the process step proceeds to step S160. In step S160, the pixel signals of the scanning row are transmitted to the memory 505 and temporarily stored. After that, the process returns to step S120 to continue the failure detection operation. On the other hand, as a result of the classification, when the output expected value does not coincide with the actual output value, the process proceeds to step S170. In step S170, it is determined that there is an abnormality in the imaging operation, and an alert is notified to the main control unit 513 or the alert device 512. The alert device 512 causes the display unit to display that an abnormality has been detected. Thereafter, in step S180, the photoelectric conversion device 502 is stopped, and the operation of the photodetection system 501 is ended.

In the present embodiment, an example in which the flowchart is looped for each row is described, but the flowchart may be looped for each plurality of rows, or the failure detection operation may be performed for each frame. The alert of step S170 may be notified to the outside of the vehicle via a wireless network.

In addition, in the present embodiment, the control in which the own vehicle does not collide with another vehicle has been described, but the present disclosure is also applicable to control in which the vehicle follows another vehicle and performs automatic driving, control in which the own vehicle performs automatic driving so as not to protrude from a lane, and the like. Further, the photodetection system 501 is not limited to a vehicle such as an own vehicle, and may be applied to, for example, other movable object (mobile device) of a ship, an aircraft, an industrial robot, or the like. In addition, the present disclosure is not limited to the movable object and may be widely applied to equipment using object recognition, such as intelligent transport systems (ITS).

### Seventeenth Embodiment

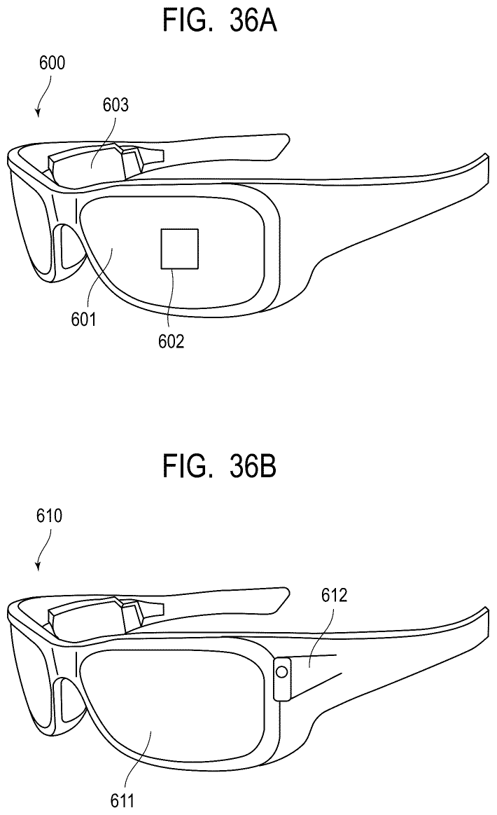

A photodetection system according to a seventeenth embodiment will be described with reference to FIG. 36A and FIG. 36B. FIG. 36A and FIG. 36B are schematic diagrams illustrating configuration examples of the photodetection system according to the present embodiment. In the present embodiment, an application example to eyeglasses (smart glasses) will be described as a photodetection system to which the photoelectric conversion device 100 according to any one of the first to twelfth embodiments is applied.

FIG. 36A illustrates eyeglasses 600 (smart glasses) according to one application example. The eyeglasses 600 include lenses 601, a photoelectric conversion device 602, and a control device 603.

The photoelectric conversion device 602 is the photoelectric conversion device 100 described in any one of the first to twelfth embodiments and is provided on the lens 601. One photoelectric conversion device 602 may be provided, or a plurality of photoelectric conversion devices may be provided. When a plurality of photoelectric conversion devices 602 are used, a combination of a plurality of types of photoelectric conversion devices 602 may be used. The arrangement position of the photoelectric conversion device 602 is not limited to FIG. 36A. A display device including a light emitting device such as an organic light emitting diode (OLED) or an LED may be provided on the back surface side of the lens 601.

The control device 603 functions as a power supply that supplies power to the photoelectric conversion device 602 and the display device. The control device 603 has a function of controlling the operations of the photoelectric conversion device 602 and the display device. The lens 601 may be provided with an optical system for focusing light on the photoelectric conversion device 602.

FIG. 36B illustrates eyeglasses 610 (smart glasses) according to another application example. The eyeglasses 610 include lenses 611 and a control device 612. A photoelectric conversion device corresponding to the photoelectric conversion device 602 and a display device may be mounted on the control device 612. The lens 611 is provided with a photoelectric conversion device in the control device 612 and an optical system for projecting light from the display device, and an image is projected thereon. The control device 612 functions as a power supply that supplies power to the photoelectric conversion device and the display device and has a function of controlling operations of the photoelectric conversion device and the display device.

The control device 612 may further include a line-of-sight detection unit that detects the line of sight of the wearer. In this case, an infrared light emitting unit may be provided in the control device 612, and infrared light emitted from the infrared light emitting unit may be used for detection of a line of sight. Specifically, the infrared light emitting unit emits infrared light to the eyeball of the user who is watching the display image. A captured image of the eyeball is obtained by detecting reflected light of the emitted infrared light from the eyeball by an imaging unit having a light receiving element. By providing a reduction unit that reduces light from the infrared light emitting unit to the display unit in a plan view, it is possible to reduce degradation of image quality.

The line of sight of the user with respect to the display image may be detected from the captured image of the eyeball obtained by capturing the infrared light. Any known technique may be applied to the line-of-sight detection using the captured image of the eyeball. As an example, a line-of-sight detection method based on a Purkinje image due to reflection of irradiation light on the cornea may be used. More specifically, the line-of-sight detection process based on the pupil corneal reflection method is performed. The line of sight of the user may be detected by calculating a line-of-sight vector representing the orientation (rotation angle) of the eyeball based on the image of the pupil included in the captured image of the eyeball and the Purkinje image using the pupil corneal reflex method.

The display device according to the present embodiment may include a photoelectric conversion device having a light receiving element, and may be configured to control a display image based on line-of-sight information of a user from the photoelectric conversion device. Specifically, the display device determines, based on the line-of-sight information, a first viewing area that the user gazes at and a second viewing area other than the first viewing area. The first viewing area and the second viewing area may be determined by a control device of the display device or may be determined by an external control device. When the determination is made by the external control device, the determination result is transmitted to the display device via communication. In the display area of the display device, the display resolution of the first viewing area may be controlled to be higher than the display resolution of the second viewing area. That is, the resolution of the second viewing area may be lower than the resolution of the first viewing area.

The display area may include a first display area and a second display area different from the first display area, and an area having a high priority may be determined from the first display area and the second display area based on the line-of-sight information. The first display area and the second display area may be determined by a control device of the display device or may be determined by an external control device. When the determination is made by the external control device, the determination result is transmitted to the display device via communication. The resolution of the high priority area may be controlled to be higher than the resolution of the region other than the high priority area. That is, the resolution of the area having a relatively low priority may be lowered.

Note that the artificial intelligence (AI) may be used to determine the first viewing area or the area with a high priority. The AI may be a model configured to estimate an angle of the line of sight and a distance to a target object ahead of the line of sight from the image of the eyeball using the image of the eyeball and the direction in which the eyeball of the image is actually viewed as teacher data. The AI program may be included in the display device, the photoelectric conversion device, or the external device. When the external device has the program, the information may be transmitted to the display device via communication.

In the case of performing display control based on visual recognition detection, the present disclosure may be preferably applied to smart glasses further including a photoelectric conversion device that captures an image of the outside. Smart glasses may display captured external information in real time.

### MODIFIED EMBODIMENTS

The present disclosure is not limited to the above embodiments, and various modifications are possible.

For example, an example in which a part of the configuration of any of the embodiments is added to another embodiment or an example in which a part of the configurations of any of the embodiments is substituted with some of the configurations of another embodiment is also an embodiment of the present disclosure.

Further, the circuit configuration of the pixel 12 is not limited to the above-described embodiments. For example, a switch such as a transistor may be provided between the photoelectric conversion element 22 and the quenching element 32 or between the photoelectric conversion element 22 and the signal processing unit 30 to control the electrical connection state therebetween. Further, a switch such as a transistor may be provided between the node to which the voltage VH is supplied and the quenching element 32 and/or between the node to which the voltage VL is supplied and the photoelectric conversion element 22 to control an electrical connection state therebetween. A plurality of photoelectric conversion elements 22 may be provided for one pixel 12.

Further, in the circuit configuration of the pixel 12 of the above-described embodiment, the signal charge (electrons) is taken out from the cathode side with the anode side of the APD as the fixed potential, but the signal charge (holes) may be taken out from the anode side with the cathode side of the APD as the fixed potential. In this case, the conductivity types of the semiconductor regions described in the above embodiments may be opposite to each other.

Further, a configuration in which a counter circuit is used as the processing circuit 36 has been described, but a time-to-digital converter (TDC) and a memory may be used instead of the counter circuit. In this case, the generation timing of the pulse signal output from the waveform shaping circuit 34 is converted into a digital signal by the TDC. A control pulse pREF (reference signal) is supplied to the TDC from the vertical scanning circuit unit 40 via the control line 14 when the timing of the pulse signal is measured. The TDC acquires, as a digital signal, a signal when an input timing of a signal output from each pixel 12 is set to a relative time with reference to the control pulse PREF.

According to the present disclosure, in a photoelectric conversion device including a through-electrode penetrating a semiconductor layer, it is possible to increase an arrangement area of an element or a circuit arranged in the semiconductor layer and to improve a degree of freedom of layout.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-211994, filed Dec. 5, 2024, which is hereby incorporated by reference herein in its entirety.

What is claimed is:

1. A photoelectric conversion device comprising:
a first semiconductor layer provided with an avalanche photodiode;
a second semiconductor layer overlapping the first semiconductor layer, in a plan view;
a first insulating portion and a second insulating portion each configured to penetrate the second semiconductor layer;
a first through-electrode penetrating the first insulating portion and electrically connected to a first electrode of the avalanche photodiode; and
a second through-electrode penetrating the second insulating portion and electrically connected to a second electrode of the avalanche photodiode,
wherein the first insulating portion and the second insulating portion are provided apart from each other in the second semiconductor layer in the plan view.

2. The photoelectric conversion device according to claim 1, further comprising:
at least one other avalanche photodiode; and
a plurality of first through-electrodes electrically connected to the avalanche photodiode and the at least one other avalanche photodiode,
wherein the plurality of first through-electrodes penetrates one first insulating portion of the avalanche photodiode and the at least one other avalanche photodiode.

3. The photoelectric conversion device according to claim 1, further comprising:
at least one other avalanche photodiode,
wherein the first through-electrode is electrically connected to the avalanche photodiode and the at least one other avalanche photodiode.

4. The photoelectric conversion device according to claim 3, further comprising a connection portion configured to electrically connect respective first electrodes of the avalanche photodiode and the at least one other avalanche photodiode to each other,
wherein the first through-electrode is electrically connected to the avalanche photodiode and the at least one other avalanche photodiode via the connection portion.

5. The photoelectric conversion device according to claim 4, wherein the connection portion is comprised of an interconnection provided over a first face of the first semiconductor layer facing the second semiconductor layer.

6. The photoelectric conversion device according to claim 4, wherein the connection portion is comprised of a semiconductor region provided in the first semiconductor layer.

7. The photoelectric conversion device according to claim 2,
wherein the avalanche photodiode and the at least one other avalanche photodiode each have a rectangular shape in the plan view and are arranged in a matrix,
wherein the first insulating portion overlaps a corner portion of the rectangular shape, in the plan view, and
wherein the second insulating portion is arranged at a position overlapping a central portion of the rectangular shape, in the plan view.

8. The photoelectric conversion device according to claim 7, wherein the first insulating portion overlaps at least one corner portion of the rectangular shape, in the plan view.

9. The photoelectric conversion device according to claim 7, wherein the first insulating portion overlaps a portion where corner portions of four adjacent avalanche photodiodes, in the plan view.

10. The photoelectric conversion device according to claim 9, wherein the first through-electrode is electrically connected to two avalanche photodiodes of the four adjacent avalanche photodiodes.

11. The photoelectric conversion device according to claim 9, wherein the first through-electrode is electrically connected to the four adjacent avalanche photodiodes.

12. The photoelectric conversion device according to claim 2, further comprising:
a plurality of second through-electrodes electrically connected to the avalanche photodiode and the at least one other avalanche photodiode; and
a plurality of second insulating portions corresponding to the plurality of second through-electrodes,
wherein the plurality of second insulating portions are provided apart from each other in the second semiconductor layer.

13. The photoelectric conversion device according to claim 12, further comprising:
a plurality of quenching elements; and
a plurality of waveform shaping circuits,
wherein the plurality of quenching elements and the plurality of waveform shaping circuits are provided in the second semiconductor layer and are each electrically connected to the avalanche photodiode via the second through-electrode, and
wherein each of the plurality of quenching elements and the plurality of waveform shaping circuits is arranged adjacent to the electrically connected second through-electrode, in the plan view.

14. The photoelectric conversion device according to claim 13,
wherein the plurality of second through-electrodes are arranged in a matrix, in the plan view, and
wherein the plurality of quenching elements and the plurality of waveform shaping circuits are alternately arranged between the second through-electrodes of the plurality of second through-electrodes, in each of a column direction and a row direction.

15. The photoelectric conversion device according to claim 13,
wherein the plurality of second through-electrodes are arranged in a matrix, in the plan view,
wherein the plurality of quenching elements are arranged between the second through-electrodes of the plurality of second through-electrodes, in one of a column direction and a row direction, and
wherein the plurality of waveform shaping circuits are arranged between the second through-electrodes of the plurality of second through-electrodes, in an other column direction and row direction.

16. The photoelectric conversion device according to claim 1, further comprising a light diffusion structure provided between the first semiconductor layer and the second semiconductor layer,
wherein the light diffusion structure is provided over a first face of the first semiconductor layer facing the second semiconductor layer.

17. The photoelectric conversion device according to claim 1, further comprising a scattering/diffraction structure provided over a second face of the first semiconductor layer opposite to a first face facing the second semiconductor layer.

18. The photoelectric conversion device according to claim 1, further comprising a microlens array provided over a second face of the first semiconductor layer opposite to a first face facing the second semiconductor layer,
wherein the microlens array includes two or more microlenses corresponding to one avalanche photodiode.

19. A photodetection system comprising:
the photoelectric conversion device according to claim 1; and
a signal processing device configured to process a signal output from the photoelectric conversion device.

20. A movable object comprising:
the photoelectric conversion device according to claim 1;
a distance information acquisition device configured to acquire distance information to an object from a parallax image, based on a signal output from the photoelectric conversion device; and
a control device configured to control the movable object based on the distance information.
